(19) United States
(12) Patent Application Publication
(10) Pub. No.: US 2023/0321862 A1
(43) Pub. Date: Oct. 12, 2023

(54) PUNCHING DEVICE AND CONTROL METHOD FOR PUNCHING DEVICE

(71) Applicant: SEIKO EPSON CORPORATION, Tokyo (JP)

(72) Inventors: Toshikazu KOTAKA, Matsumoto-Shi (JP); Hirohisa KODAIRA, Matsumoto-Shi (JP)

(21) Appl. No.: 18/298,203

(22) Filed: Apr. 10, 2023

(30) Foreign Application Priority Data
Apr. 12, 2022 (JP) 2022-065558

(51) Int. Cl. B26F 1/14

(52) U.S. Cl. CPC B26F 1/14

(57) ABSTRACT

A punching device, includes a die configured to support a paper sheet and a punch unit configured to perform a punch process, wherein the punch unit includes a pressing section, a punch that has a conical shaped tip end section and that is configured to move up and down, and a punch guide hole configured to accommodate the punch and to guide the punch in up and down movement and the die includes a hole section provided in a portion facing the punch and through which the punch is passable, a die blade provided at an upper end periphery of the hole section and configured to cut the sheet in cooperation with the punch, and after the sheet is pressed by the die and the pressing section, the punch process is performed by lowering the punch while bringing the tip end section into contact with the paper.

The present application is based on, and claims priority from JP Application Serial Number 2022-065558, filed Apr. 12, 2022, the disclosure of which is hereby incorporated by reference herein in its entirety.

### BACKGROUND

### 1. Technical Field

The present disclosure relates to a punching device and a control method for the punching device.

### 2. Related Art

In the related art, as shown in JP-A-2000-233396, there has been known a paper sheet punching device comprising a plurality of punches disposed widthwise, a plurality of dies for punching in cooperation with the punches, tie bars connecting the punches and extending widthwise, a plurality of cams installed at predetermined intervals on the tie bars for driving the tie bars in a punching direction and a counter-punching direction of the punches, and a camshaft extending widthwise for rotating the cams.

However, when the punch process is performed by the above described punching device, cutting waste having substantially the same size as the cross sectional area of the punch is generated. In recent years, there has been a demand for a device that generates a smaller amount of cutting waste.

### SUMMARY

A punching device, includes a die configured to support a paper sheet and a punch unit configured to perform a punch process on the supported sheet, wherein the punch unit includes a pressing section configured to press the sheet in cooperation with the die, a punch that has a conical shaped tip end section and that is configured to move up and down, and a punch guide hole configured to accommodate the punch and to guide the punch in up and down movement and the die includes a hole section provided in a portion facing the punch and through which the punch is passable, a die blade provided at an upper end periphery of the hole section and configured to cut the sheet in cooperation with the punch, and after the sheet is pressed by the die and the pressing section, the punch that has a conical shaped tip end section process is performed by lowering the punch and bringing the tip end section into contact with the paper.

A punching device, includes a die configured to support a paper sheet and a punch unit configured to perform a punch process on the supported sheet, wherein the punch unit includes a pressing section configured to press the sheet in cooperation with the die, a punch configured to move up and down, a punch guide hole configured to accommodate the punch and to guide the punch in up and down movement, and a liquid supply mechanism configured to supply a liquid capable of permeating the sheet to the punch guide hole and the die includes a hole section provided in a portion facing the punch and through which the punch is passable, a die blade provided at an upper end periphery of the hole section and configured to cut the sheet in cooperation with the punch, and after the sheet is pressed by the die and the pressing section, the liquid is supplied to the punch guide hole and then the punch is lowered to perform the punch process.

A control method for a punching device, the punching device including a die configured to support a paper sheet and a punch unit configured to perform a punch process on the supported sheet, wherein the punch unit includes a pressing section configured to press the sheet in cooperation with the die, a punch that has a conical shaped tip end section and that is configured to move up and down, and a punch guide hole configured to accommodate the punch and to guide the punch in up and down movement and the die includes a hole section provided in a portion facing the punch and through which the punch is passable and a die blade provided at an upper end periphery of the hole section and configured to cut the sheet in cooperation with the punch, the control method comprising: performing the punch process by, after pressing the sheet by the die and the pressing section, lowering the punch and bringing the tip end section into contact with the paper.

A control method for a punching device, the punching device including a die configured to support a paper sheet and a punch unit configured to perform a punch process on the supported sheet, wherein the punch unit includes a pressing section configured to press the sheet in cooperation with the die, a punch configured to move up and down, a punch guide hole configured to accommodate the punch and to guide the punch in up and down movement, and a liquid supply mechanism configured to supply a liquid capable of permeating the sheet to the punch guide hole and the die includes a hole section provided in a portion facing the punch and through which the punch is passable and a die blade provided at an upper end periphery of the hole section and configured to cut the sheet in cooperation with the punch, the control method comprising: performing the punch process by, after pressing the sheet by the die and the pressing section, supplying the liquid to the punch guide hole, and then lowering the punch.

### BRIEF DESCRIPTION OF THE DRAWINGS

FIG. 1 is a schematic diagram showing a configuration of a recording system according to a first embodiment.

FIG. 2 is a pattern diagram showing the configuration of a punch process section according to the first embodiment.

FIG. 3 is a block diagram showing a control configuration of the punch process section according to the first embodiment.

FIG. 4A is a pattern diagram showing a method of controlling the punch process section according to the first embodiment.

FIG. 4B is a pattern diagram showing the method of controlling the punch process section according to the first embodiment.

FIG. 4C is a pattern diagram showing the method of controlling the punch process section according to the first embodiment.

FIG. 4D is a pattern diagram showing the method of controlling the punch process section according to the first embodiment.

FIG. 4E is a pattern diagram showing the method of controlling the punch process section according to the first embodiment.

FIG. 4F is a pattern diagram showing the method of controlling the punch process section according to the first embodiment.

FIG. 4G is a pattern diagram showing the method of controlling the punch process section according to the first embodiment.

FIG. 4H is a pattern diagram showing the method of controlling the punch process section according to the first embodiment.

FIG. 4J is a pattern diagram showing the method of controlling the punch process section according to the first embodiment.

FIG. 4K is a pattern diagram showing the method of controlling the punch process section according to the first embodiment.

FIG. 4 L is a pattern diagram showing the method of controlling the punch process section according to the first embodiment.

FIG. 4M is a pattern diagram showing the method of controlling the punch process section according to the first embodiment.

FIG. 5 is a pattern diagram showing a configuration of a punch process section according to a second embodiment.

FIG. 6 is a block diagram illustrating a control configuration of the punch process section according to the second embodiment.

FIG. 7A is a pattern diagram showing a control method of the punch process section according to the second embodiment.

FIG. 7B is a pattern diagram showing the control method of the punch process section according to the second embodiment.

FIG. 7C is a pattern diagram showing the control method of the punch process section according to the second embodiment.

FIG. 7D is a pattern diagram showing the control method of the punch process section according to the second embodiment.

FIG. 7E is a pattern diagram showing the control method of the punch process section according to the second embodiment.

FIG. 7F is a pattern diagram showing the control method of the punch process section according to the second embodiment.

FIG. 7G is a pattern diagram showing the control method of the punch process section according to the second embodiment.

FIG. 7H is a pattern diagram showing the control method of the punch process section according to the second embodiment.

FIG. 7J is a pattern diagram showing the control method of the punch process section according to the second embodiment.

FIG. 7K is a pattern diagram showing the control method of the punch process section according to the second embodiment.

FIG. 7 L is a pattern diagram showing the control method of the punch process section according to the second embodiment.

FIG. 7M is a pattern diagram showing the control method of the punch process section according to the second embodiment.

FIG. 7 N is a pattern diagram showing the control method of the punch process section according to the second embodiment.

FIG. 8 is a pattern diagram showing a configuration of a punch process section according to a third embodiment.

FIG. 9 is a block diagram illustrating a control configuration of the punch process section according to the third embodiment.

FIG. 10A is a pattern diagram showing the control method of the punch process section according to the third embodiment.

FIG. 10B is a pattern diagram showing the control method of the punch process section according to the third embodiment.

FIG. 10C is a pattern diagram showing the control method of the punch process section according to the third embodiment.

FIG. 10D is a pattern diagram showing the control method of the punch process section according to the third embodiment.

FIG. 10E is a pattern diagram showing the control method of the punch process section according to the third embodiment.

FIG. 10F is a pattern diagram showing the control method of the punch process section according to the third embodiment.

FIG. 10G is a pattern diagram showing the control method of the punch process section according to the third embodiment.

FIG. 10H is a pattern diagram showing the control method of the punch process section according to the third embodiment.

FIG. 10J is a pattern diagram showing the control method of the punch process section according to the third embodiment.

FIG. 10K is a pattern diagram showing the control method of the punch process section according to the third embodiment.

FIG. 10 L is a pattern diagram showing the control method of the punch process section according to the third embodiment.

FIG. 10M is a pattern diagram showing the control method of the punch process section according to the third embodiment.

FIG. 10 N is a pattern diagram showing the control method of the punch process section according to the third embodiment.

### DESCRIPTION OF EMBODIMENTS

### 1. First Embodiment

First, a configuration of a recording system 1 including a punch process section 46 as a punching device will be described.

An X-Y-Z coordinate system shown in each drawing is a orthogonal coordinate system, in which a direction along an X-axis indicates the device depth direction, a direction along a Y-axis indicates the device width direction, and a direction along a Z-axis indicates the device height direction (vertical direction).

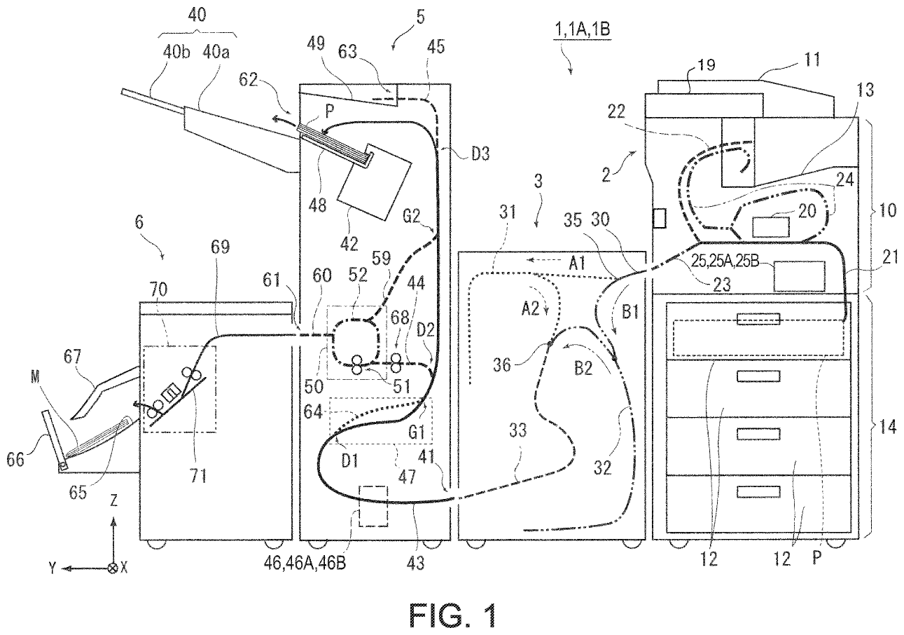

As shown in FIG. 1, a recording system 1 of the present embodiment includes a recording unit 2, an intermediate unit 3, a first unit 5, and a second unit 6 in this order in a +Y direction.

The recording unit 2 performs recording on a medium P (for example, a paper sheet) to be transported. The intermediate unit 3 receives the recorded medium P from the recording unit 2 and delivers the medium P to the first unit 5, and mainly performs a function of promoting drying of the medium P. The first unit 5 includes a drying section 50 that performs a drying process on the received medium P, and an end binding section 42 that performs an end binding process in which the media P after recording in the recording unit 2 are bundled and the ends thereof are bound. Further, the first unit 5 includes a punch process section 46 that performs punch process on the received medium P. The second unit 6 includes a saddle stitch folding mechanism 70 that binds and folds the center of the bundle of medium P after recording in the recording unit 2 into a booklet.

The recording unit 2 is configured as a multifunction device including a printer section 10 having a line head 20 as a recording section that performs recording on the medium P, and a scanner section 11. In the present embodiment, the line head 20 is configured as a so-called inkjet type recording head that performs recording by ejecting ink onto the medium P.

A cassette accommodation section 14 including a plurality of medium accommodation cassettes 12 is provided in a lower section of the printer section 10. The medium P stored in the medium accommodation cassette 12 is sent to a recording region of the line head 20 through a feed path 21 indicated by a solid line, and a recording operation is performed. The medium P after recording by the line head 20 is sent to either a first discharge path 22, which is a path for discharging the medium P to a post recording discharge tray 13 provided above the line head 20, or a second discharge path 23, which is a path for sending the medium P to the intermediate unit 3.

In FIG. 1, the first discharge path 22 is indicated by a dashed line, and the second discharge path 23 is indicated by an one-dot chain line. The second discharge path 23 extends in the +Y direction of the recording unit 2 and delivers the medium P to a reception path 30 of the intermediate unit 3.

In addition, the recording unit 2 includes an inversion path 24 indicated by a two-dot chain line in FIG. 1, and is configured to be capable of performing double-sided recording in which after recording on a first surface of the medium P, the medium P is inversed and recording on a second surface is performed. One or more pairs of rollers (not shown), as an example of a unit that transports the medium P, are disposed in each of the feed path 21, the first discharge path 22, the second discharge path 23, and the inversion path 24.

The recording unit 2 is provided with a control section 25 that controls operations related to transport and recording of the medium P in the recording unit 2. The recording system 1 is configured such that the recording unit 2, the intermediate unit 3, the first unit 5, and the second unit 6 are mechanically and electrically connected to each other, and the medium P can be transported from the recording unit 2 to the second unit 6. The control section 25 in this embodiment can control various operations in the intermediate unit 3, the first unit 5, and the second unit 6 connected to the recording unit 2.

The recording unit 2 includes an operation section 19, and is configured such that various settings and execution commands relating to various processes in the recording unit 2, the intermediate unit 3, the first unit 5, and the second unit 6 can be input from the operation section 19. The operation section 19 includes a display panel (not illustrated), and is configured to be capable of displaying various kinds of information on the display panel.

The intermediate unit 3 passes the medium P received from the recording unit 2 to the first unit 5. The intermediate unit 3 is disposed between the recording unit 2 and the first unit 5. The medium P transported through the second discharge path 23 of the recording unit 2 is received by the intermediate unit 3 from the reception path 30 and is transported toward the first unit 5. The reception path 30 is indicated by a solid line in FIG. 1.

In the intermediate unit 3, there are two transport paths for transporting the medium P. The first transport path is a path in which medium P transported from the reception path 30 to the merging path 33 via a first switchback path 31 indicated by a dotted line in FIG. 1. The second transport path is a path in which medium P transported from the reception path 30 to the merging path 33 via a second switchback path 32 indicated by a two-dot chain line in FIG. 1.

The first switchback path 31 is a path that receives the medium P in the direction of arrow A1 and then switches back the medium P in the direction of arrow A2. The second switchback path 32 is a path that receives the medium P in the direction of arrow B1 and then switches back the medium P in the direction of arrow B2.

The reception path 30 branches into the first switchback path 31 and the second switchback path 32 at a branch section 35. A flap (not illustrated) that switches the destination of the medium P to either the first switchback path 31 or the second switchback path 32 is provided in the branch section 35.

In addition, the first switchback path 31 and the second switchback path 32 merge at the merging section 36. Therefore, even when the medium P is sent from the reception path 30 to either the first switchback path 31 or the second switchback path 32, the medium P can be delivered to the first unit 5 via the common merging path 33.

The intermediate unit 3 receives the medium P from the recording unit 2 into the reception path 30 in a state in which the recording surface on which recording was performed last by the line head 20 faces upward, however, the medium P is curved and reversed in the merging path 33, and the recording surface on which recording was performed last is in a state of facing downward.

Therefore, the medium P in the state in which the recording surface on which recording was performed last faces downward is passed from the +Y direction of the intermediate unit 3 to a first transport path 43 of the first unit 5.

In each of the reception path 30, the first switchback path 31, the second switchback path 32, and the merging path 33, one or more rollers (not illustrated) are disposed as an example of a unit that transports the medium P.

In a case where recording is successively performed on a plurality of media P in the recording unit 2, the media P that have entered the intermediate unit 3 are alternately sent to a transport path that passes through the first switchback path 31 and a transport path that passes through the second switchback path 32. Accordingly, it is possible to increase the throughput of the transport of the medium P in the intermediate unit 3.

In addition, in a case of a configuration in which recording is performed by discharging ink to the medium P in the manner of the line head 20 of the present embodiment, when the medium P is wet when a process is performed in a first unit 5 or a second unit 6 (to be described later), a recording surface may be rubbed or consistency of the medium P may become poor. By delivering the medium P after recording from the recording unit 2 to the first unit 5 via the intermediate unit 3, it is possible to take a long transport time until the medium P after recording is sent to the first unit 5, and to further dry the medium P before reaching the first unit 5 or the second unit 6.

The first unit 5 includes a receiving section 41 that receives the medium P from the intermediate unit 3 below in a −Y direction. The medium P transported through the merging path 33 of the intermediate unit 3 enters the first unit 5 from the receiving section 41 and is passed to the first transport path 43.

The first unit 5 includes a drying section 50 that performs a process on the medium P received from the receiving section 41, and the end binding section 42 that performs a process on the medium P received from the receiving section 41 or on the medium P processed by the drying section 50.

The first unit 5 includes the first transport path 43 that sends the medium P received from the receiving section 41 to the end binding section 42, and a second transport path 44 that branches from the first transport path 43 at a second branch section D2 and that sends the medium P to the drying section 50. A flap (not illustrated) that switches the transport destination of the medium P between the first transport path 43 and the second transport path 44 is provided in the second branch section D2.

The end binding section 42 is a configuration section that performs an end binding process of binding an end portion of the medium P, for example, such as a corner portion on one side of the medium P or one side of the medium P. The end binding section 42 includes a stapler as an example.

The drying section 50 is a configuration section that performs a drying process on the medium P. In this embodiment, the drying section 50 dries the medium P by heating the medium P. The medium P after the drying process by the drying section 50 is sent to one of the end binding section 42 or the saddle stitch folding mechanism 70. The saddle stitch folding mechanism 70 is provided in the second unit 6.

The punch process section 46 is provided at a position close to the receiving section 41 in the first transport path 43 through which passes the medium P that was received in the first unit 5, and is configured to be able to execute a punch process upstream in the first transport path 43. In the recording system 1, the punch process section 46 may or may not perform the punch process on the medium P that is received from the receiving section 41. The configuration of the punch process section 46 will be described later.

The medium P received from the receiving section 41 can be sent to a process tray 48 or the second unit 6 through the first transport path 43. In the process tray 48, the media P are stacked on the process tray 48 with their trailing ends in the transport direction aligned. When a predetermined number of sheets of media P are stacked on the process tray 48, the end binding process by the end binding section 42 can be performed on a rear end of the media P. The first unit 5 includes a second discharge section 62 that discharges the media P in the +Y direction. The first unit 5 includes a first discharge section 61 and a third discharge section 63 in addition to the second discharge section 62, and is configured to be able to discharge the medium P also from these discharge sections.

The media P processed by the end binding section 42 are discharged from the second discharge section 62 to the outside of the first unit 5 by a discharge unit (not illustrated), and placed on a first tray 40 that receives the media P discharged from the second discharge section 62. The first tray 40 protrudes from the first unit 5 in the +Y direction. In the present embodiment, the first tray 40 includes a base section 40a and an extension section 40b, and the extension section 40b is configured to be storable in the base section 40a.

Further, a third transport path 45 branched from the first transport path 43 at a third branch section D3 downstream of the second branch section D2 is connected to the first transport path 43. A flap (not illustrated) that switches the transport destination of the medium P between the first transport path 43 and the third transport path 45 is provided in the third branch section D3.

An upper tray 49 is provided in the upper section of the first unit 5. The third transport path 45 is continuous from the third branch section D3 to the third discharge section 63, and the medium P transported through the third transport path 45 is discharged from the third discharge section 63 to the upper tray 49 by a discharge unit (not illustrated). That is, the medium P received from the receiving section 41 can be discharged to the upper tray 49 without passing through the end binding section 42.

The first transport path 43 is provided with an overlap path 64 that branches from the first transport path 43 at a first branch section D1 and merges again with the first transport path 43 at a first merging section G1. The overlap path 64 configures an overlap process section 47 in which two sheets of the media P are overlapped and sent to the drying section 50 or the end binding section 42. The preceding medium P transported in advance is sent to the overlap path 64, and the following medium P transported through the first transport path 43 and the preceding medium P merge at the first merging section G1, so that the preceding medium P and the following medium P can be transported downstream from the first merging section G1 in an overlapping manner. The overlap process section 47 may have a configuration in which a plurality of overlapping paths 64 are provided and three or more sheets of the media P are overlapped and sent downstream.

In the first unit 5, the overlap process section 47 is located vertically below the drying section 50, and the drying section 50, the end binding section 42, and the overlap process section 47 have portions that overlap each other as viewed in the vertical direction, that is, as viewed from above. Note that a configuration may be employed in which only the drying section 50 and the overlap process section 47 overlap or only the end binding section 42 and the overlap process section 47 overlap.

By disposing the drying section 50, the end binding section 42, and the overlap process section 47 in such a positional relationship, it is possible to suppress an increase in the horizontal dimension of the device and realize a miniaturize in the size of the device.

One or more pairs of rollers are disposed in each of the first transport path 43, the second transport path 44, and the third transport path 45 in the first unit 5 as an example of a unit that transports the medium P.

The drying section 50 includes a heat roller pair 51 as a drying process unit that performs the drying process on the medium P, and a looped transport path 52 that includes the heat roller pair 51 and is capable of transporting the medium P in a circulating manner. The second transport path 44 branched from the first transport path 43 merges with the looped transport path 52 upstream of the heat roller pair 51, and the medium P can be fed by the transport roller pair 68 provided in the second transport path 44 and introduced into the looped transport path 52.

In the present embodiment, the lower roller of the heat roller pair 51 is a drying drive roller driven by a drive source (not illustrated), and the upper roller thereof is a drying driven roller rotated by the rotation of the drying drive roller. The drying drive roller is heated by a heater (not illustrated), whereby the drying drive roller generates heat, and the medium P is dried. However, at least one of the rollers constituting the heat roller pair 51 may be heated, and both of the rollers may be heated.

However, the medium P sent from the intermediate unit 3 enters the second transport path 44 from the receiving section 41 of the first unit 5 via the first transport path 43 in the state in which the recording surface on which recording was performed last faces downward. Then, the medium P is nipped by the heat roller pair 51 in the state in which the recording surface on which recording was performed last faces downward. Therefore, among the heat roller pair 51, the roller to be heated is preferably a roller that is in contact with the recording surface of the medium P on which recording was performed last faces to the heat roller pair 51.

Since the drying section 50 includes the looped transport path 52 and is configured to be able to circularly transport the medium P in the looped transport path 52, it is possible to perform the drying process by the heat roller pair 51 a plurality of times by circularly transporting the medium P a plurality of times. Therefore, the medium P can be dried more reliably.

Further, by providing the looped transport path 52, it is possible to suppress an increase in the cost of the device and to suppress power consumption as compared with, for example, a case where a plurality of heat roller pairs 51 are provided in the transport path.

In the recording system 1, heating by the heat roller pair 51 is controlled by the control section 25 provided in the recording unit 2. The control section 25 can control the heating of the heat roller pair 51 according to conditions. Examples of the conditions include, in addition to the type, the rigidity, the thickness, and the basis weight of the medium P, the ejection amount of ink ejected onto the medium P during recording in the recording unit 2, whether recording on the medium P is double-sided recording or single-sided recording, and environmental conditions such as temperature and humidity during drying.

By controlling the heating by the heat roller pair 51 according to these conditions, the medium P can be dried more appropriately. Examples of the control of heating by the heat roller pair 51 include the presence or absence of heating, the temperature in the case of heating, whether or not to perform pre-heating in the case of heating, and the timing of starting heating of the heat roller pair 51.

In the heat roller pair 51, one drying driven roller is pressed against the other drying driving roller by a pressing unit (not illustrated) such as a spring, and the pressing force by the pressing unit can be changed. The nip pressure in the heat roller pair 51 can be adjusted by controlling a pressing force changing unit (not illustrated) for changing the pressing force by the pressing unit by the control section 25. The nip pressure in the heat roller pair 51 is desirably changed in accordance with conditions. As the conditions, the same conditions as those for controlling the heating by the heat roller pair 51 can be used.

A fourth transport path 59 is connected to the looped transport path 52. The fourth transport path 59 is a path that merges with the first transport path 43 at the second merging section G2 and returns the medium P after the drying process by the heat roller pair 51 to the first transport path 43.

A fifth transport path 60 is connected to the looped transport path 52. The fifth transport path 60 is a path that leads to the first discharge section 61, and is a path that feeds the medium P toward the second unit 6 after the drying process by the heat roller pair 51, toward the second unit 6.

The first unit 5 includes a switching flap (not illustrated) as a switching member capable of switching between a first state in which the medium P that is processed by the drying section 50 is sent to the first discharge section 61 and a second state in which the medium P that is processed by the drying section 50 is sent to the end binding section 42.

It should be noted that the drying section 50 may be configured without the looped transport path 52. In addition, in the embodiment, the drying section 50 that dries the medium P by heating the medium P from outside has been described, but the drying section 50 may have, for example, a configuration in which the medium P is dried by blowing air against the medium P.

The second unit 6 is provided below the first tray 40 of the first unit 5 so as to be detachable from and attachable to the first unit 5.

The medium P passed from the first discharge section 61 of the first unit 5 to the second unit 6 is transported on the transport path 69 and sent to the saddle stitch folding mechanism 70. The saddle stitch folding mechanism 70 includes a stack section 71 as a stacking section that stacks the medium P, and can form a booklet by binding a bundle of the media P stacked in the stack section 71 at a saddle stitch position and then folding the bound bundle at the saddle stitch position.

The media bundle M subjected to the saddle stitching process by the saddle stitching folding mechanism 70 is discharged to a second tray 65. The second tray 65 includes the restriction section 66 at the tip end in the +Y direction which is the medium discharge direction, and suppresses the media bundle M discharged to the second tray 65 from protruding from the second tray 65 in the medium discharge direction or falling from the second tray 65. A guide section 67 guides the media bundle M discharged from the second unit 6 to the second tray 65.

Next, a detailed configuration of the punch process section 46 will be described.

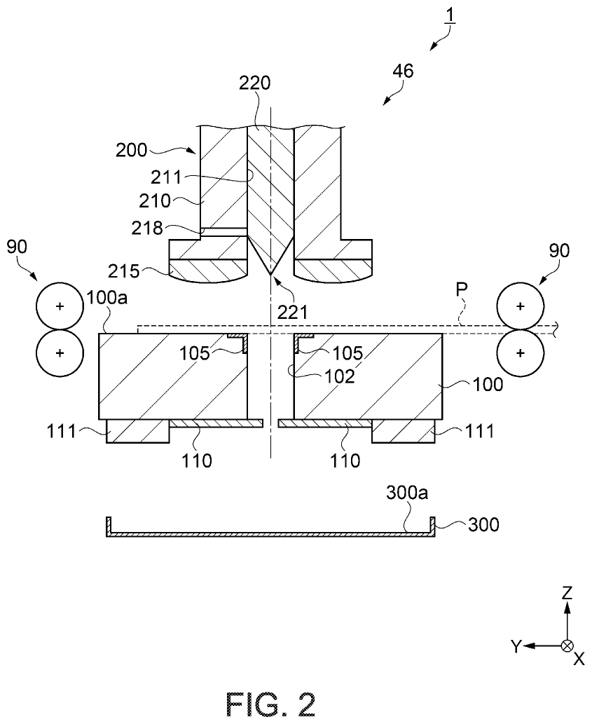

As shown in FIG. 2, the punch process section 46 includes a die 100 that can support the medium P, and a punch unit 200 that performs a punch process on the supported medium P. FIG. 2 is a cross sectional view of the punch process section 46 as viewed in a +X direction.

The punch unit 200 includes a pressing section 215 that presses the medium P in cooperation with the die 100, a punch 220 that can move up and down, and a punch guide 210 that accommodates the punch 220 and that guides the upward and downward moving punch 220.

The punch 220 is formed of steel. The punch 220 has a cylindrical rod shape. The punch 220 has a conical shaped tip end section 221. The punch 220 is disposed along the Z-axis so that the tip end section 221 is oriented in a −Z direction. Note that two punches 220 according to the present embodiment are disposed at a predetermined interval in the direction along the X-axis.

The punch guide 210 is formed of steel. The punch guide 210 has a punch guide hole 211. The punch guide hole 211 is formed in a cylindrical shape having a circular inner diameter along the Z-axis. The punch guide hole 211 accommodates the punch 220. Two punch guide holes 211 according to the present embodiment are formed in accordance with the number of the punches 220 to be disposed.

The pressing section 215 is disposed at the −Z direction end section of the punch guide 210. The pressing section 215 is formed of an elastic body (for example, a rubber member). Accordingly, damage to the medium P can be suppressed when the medium P is pressed.

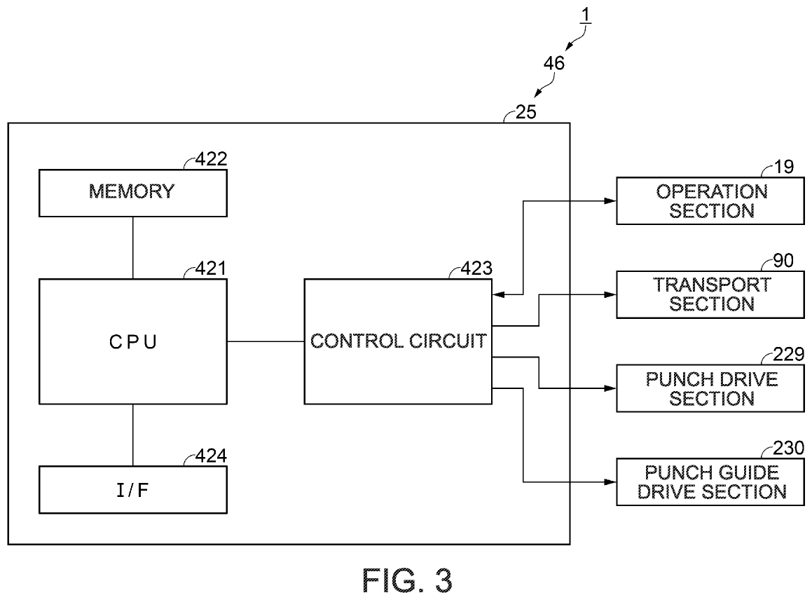

The punch guide 210 is moved up and down with respect to the die 100 by a punch guide drive section 230 (FIG. 3). The punch guide drive section 230 is composed of, for example, a cam mechanism, an air pressure mechanism, a hydraulic mechanism, or the like.

The punch 220 is moved up and down with respect to the die 100 along the punch guide hole 211 by a punch drive section 229 (FIG. 3). The punch drive section 229 is composed of, for example, a cam mechanism, an air pressure mechanism, a hydraulic mechanism, or the like.

Further, the punch guide 210 is formed with a vent hole 218 communicating with the outside from the punch guide hole 211.

The die 100 is disposed below the punch guide 210. The die 100 has a substantially rectangular parallelepiped shape and is made of steel. A support surface 100a, which is the upper surface of the +Z direction end surface of the die 100, forms a flat surface. The support surface 100a is disposed in an X-Y plane. The medium P is supported on the support surface 100a.

A hole section 102 is formed in a portion of the die 100 facing the punch 220. The hole section 102 is a through hole formed in a direction along the Z-axis of the die 100. The hole section 102 is formed in such a size that the lowering punch 220 can pass through.

A die blade 105 that cuts (punching) the medium P in cooperation with the punch 220 is disposed at the upper end periphery of the hole section 102 of the die 100. The die blade 105 is formed of steel.

In a lower portion of the hole section 102 of the die 100, a brush 110 is disposed so as to abut against the tip end section 221 of the lowered punch 220. One end portion of the brush 110 is a lower end portion of the die 100 and is held by a brush holder 111 provided at a peripheral section of the hole section 102. The brush 110 is disposed such that the other end portion (tip end section) of the brush 110 is positioned at the center portion of the hole section 102 in a plan view. The brush 110 is made of a plant material, an animal material, a synthetic fiber, or the like. As a result, the tip end section 221 of the punch 220 inserted into the hole section 102 contacts the brush 110, and waste (cutting waste W) adhered to the tip end section 221 can be removed.

Further, below the hole section 102 of the die 100, a receiving section 300 for receiving cutting waste W generated when the punch process is performed is disposed. The receiving section 300 is formed in the shape of a bottomed box having an open upper portion. The area of the bottom surface 300a of the receiving section 300 is larger than the diameter dimension of the hole section 102. The bottom surface 300a has a flat surface and is disposed opposite the lower end surface of the die 100. Accordingly, it is possible to easily collect the cutting waste W generated in the punch process.

In addition, the punch process section 46 includes a transport section 90 for transporting the medium P onto the support surface 100a of the die 100 and transporting the medium P out after the punch process. The transport section 90 of the present embodiment is a roller pair. The transport section 90 is disposed on the upstream side and the downstream side in the transport direction of the medium P with respect to the die 100. The transport section 90 is driven by drive force of a motor or the like. Accordingly, it is possible to easily transport the medium P in and out with respect to the die 100 (the punch process section 46). The recording system 1 may include the transport section.

Next, a control configuration of the punch process section 46 of the recording system 1 will be described.

As shown in FIG. 3, the recording system 1 includes the control section 25 that controls various operations performed in the recording system 1. The control section 25 includes a CPU 421, a memory 422, a control circuit 423, and an interface (I/F) 424. The CPU 421 is an arithmetic process unit. The memory 422 is a storage device that secures an area for storing a program for calculation in the CPU 421 or a work area, or the like, and includes storage elements such as a RAM and EEPROM. In the punch process section 46, the control circuit 423 is connected to the operation section 19, the transport section 90, the punch drive section 229, and the punch guide drive section 230. When the control section 25 obtains, for example, an execution command from the operation section 19 or record data or the like from an external information processing terminal or the like via the I/F 424, the CPU 421 executes arithmetic processes in accordance with various programs, and controls each drive unit or the like via the control circuit 423.

Next, a control method of the punch process section 46 will be described.

In the punch process section 46 of the present embodiment, after the medium P is pressed by the die 100 and the pressing section 215, the punch process is performed by lowering the punch 220 while the tip end section 221 is brought into contact with the medium P.

A specific description will be given below.

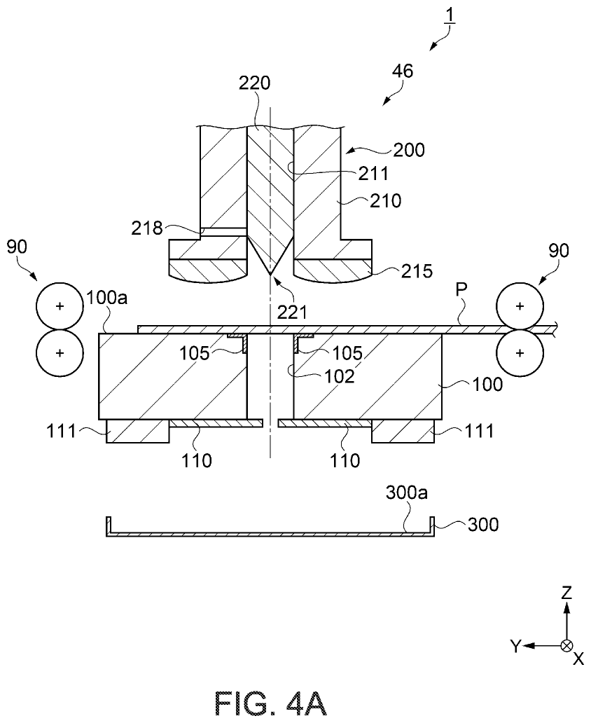

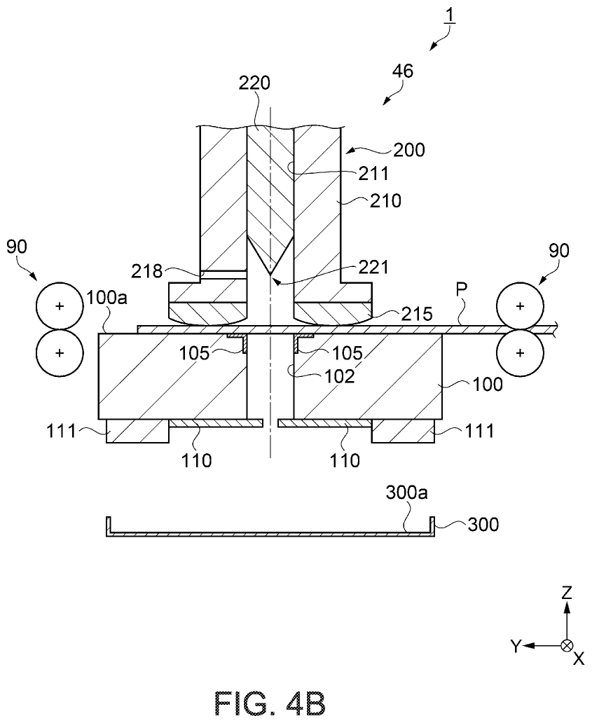

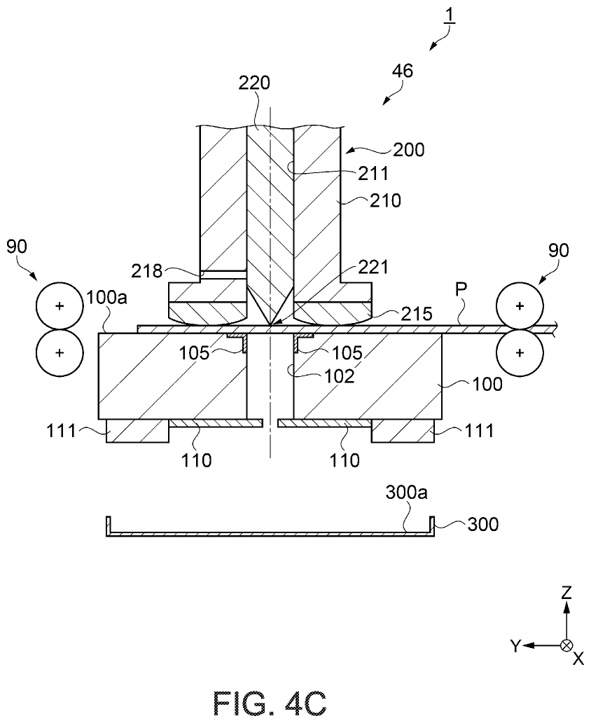

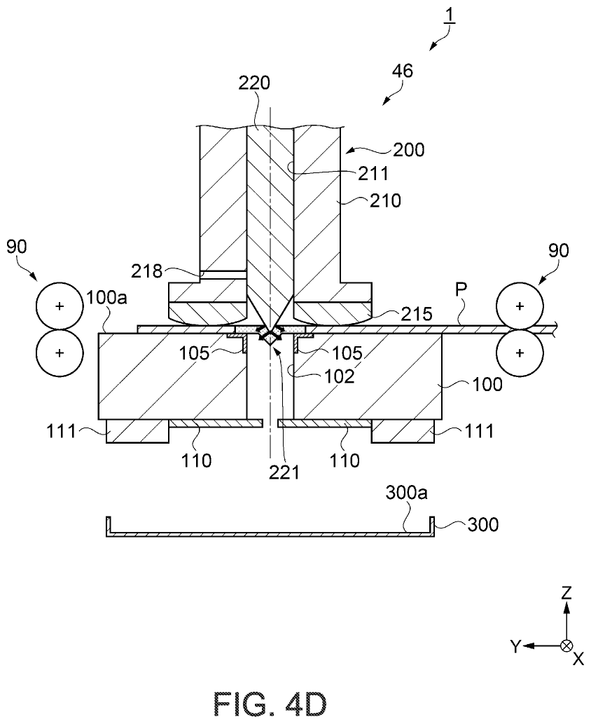

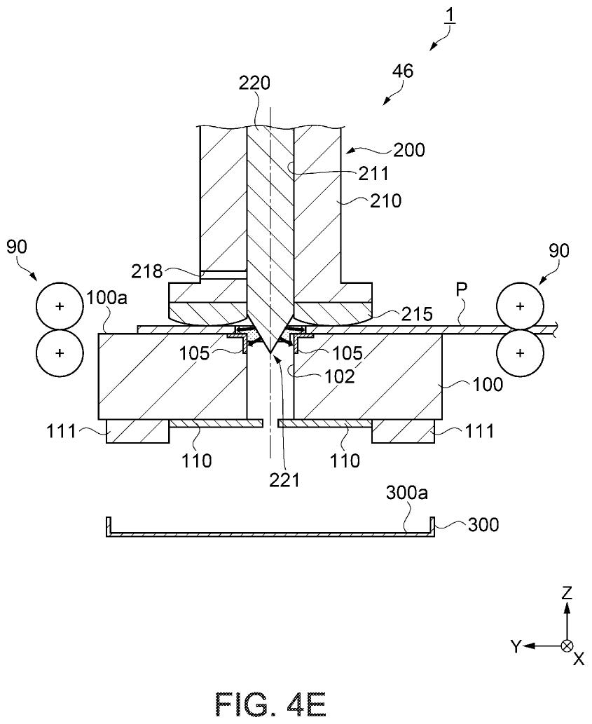

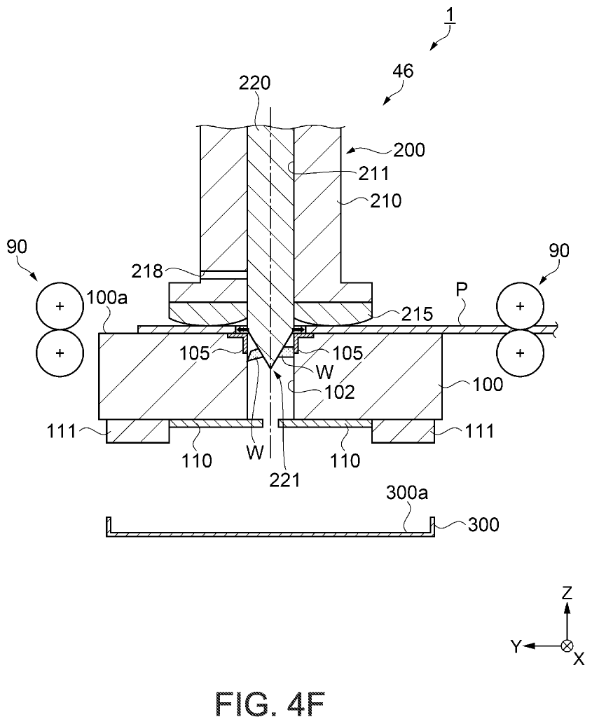

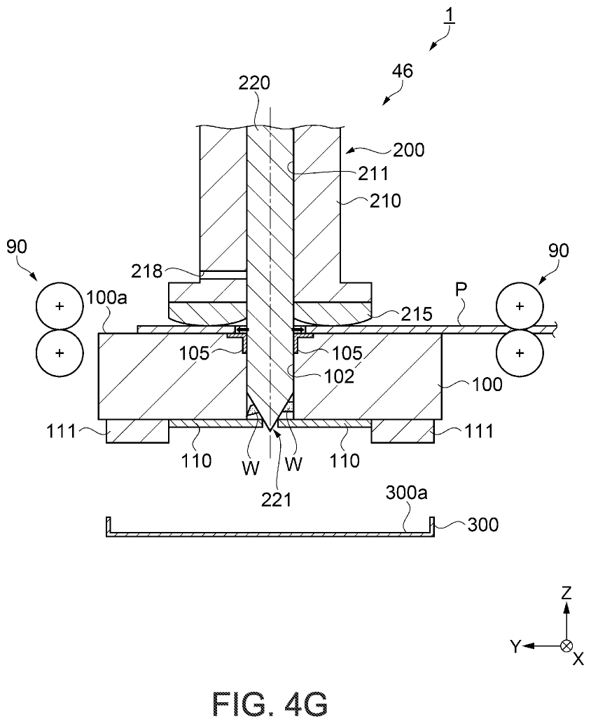

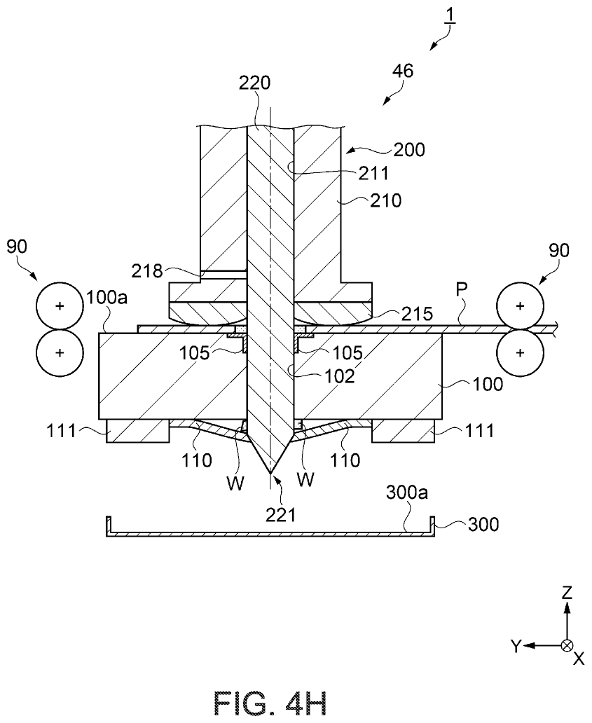

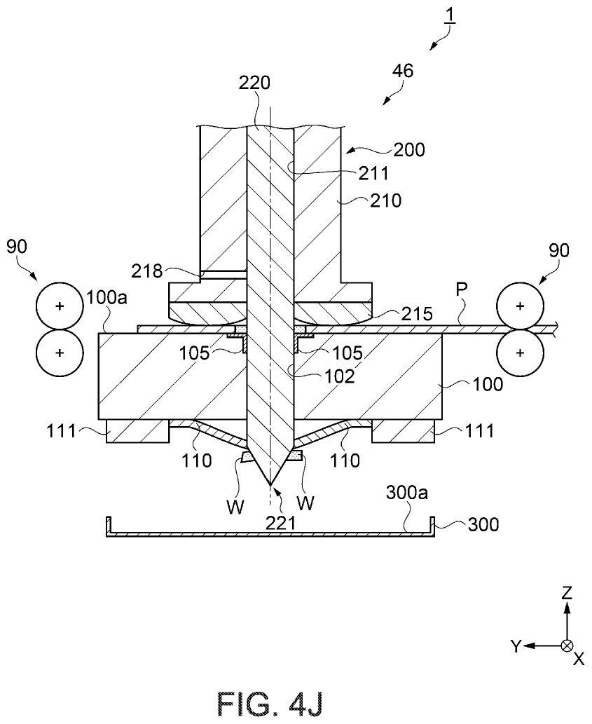

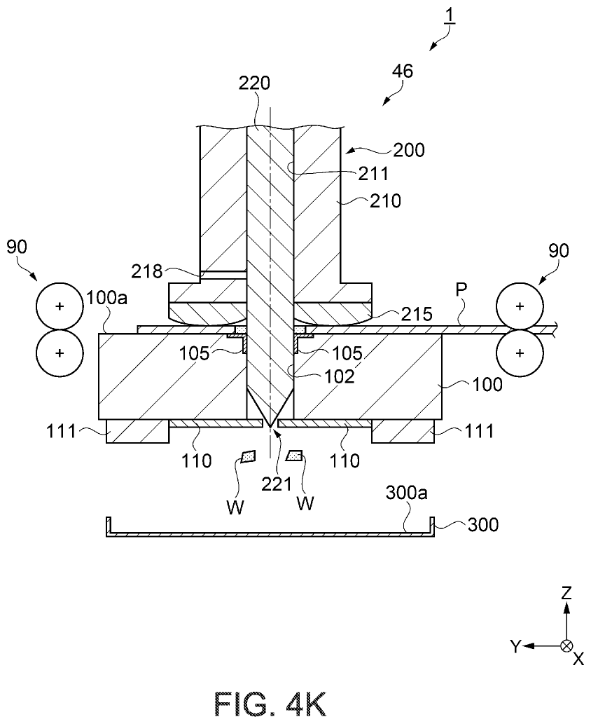

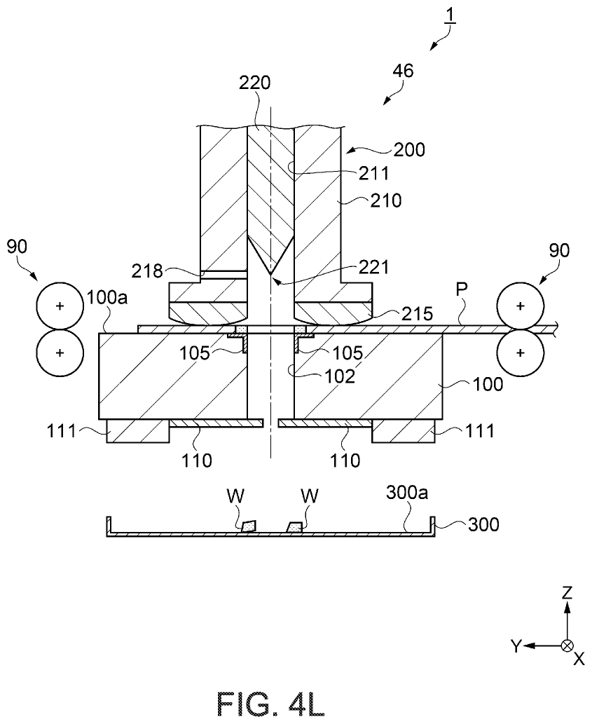

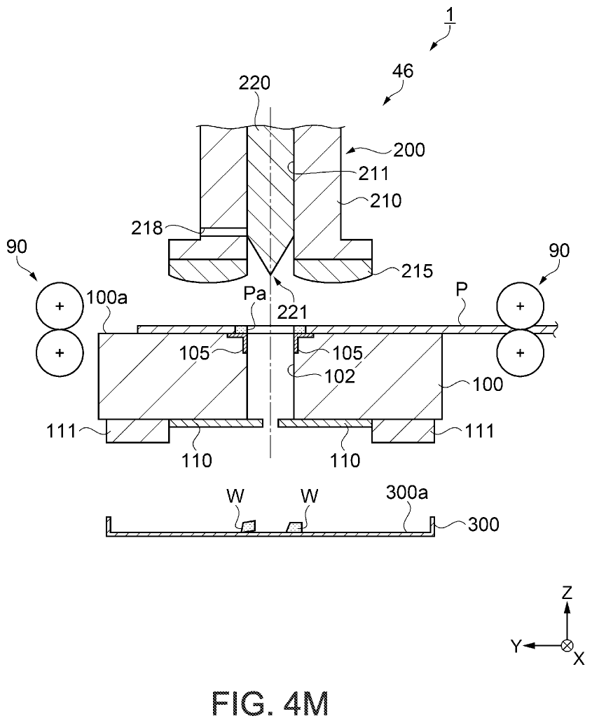

First, as shown in FIG. 4A, the control section 25 drives the transport section 90 to transport the medium P. As a result, the medium P is supported by the support surface 100a of the die 100. When the medium P is supported at a predetermined position, the drive of the transport section 90 is stopped.

At this time, the punch guide 210 and the punch 220 are held above the die 100.

Next, as shown in FIG. 4B, the control section 25 causes the punch guide 210 to lower and causes the pressing section 215 to press the medium P downward. Accordingly, the medium P is pressed by the die 100 and the pressing section 215.

At this time, the punch 220 is held above the die 100.

Next, as shown in FIG. 4C, the control section 25 lowers the punch 220. When the punch 220 is lowered, the inside of the punch guide hole 211 is closed off by the punch guide 210, the pressing section 215, the punch 220, and the medium P. When the punch 220 is lowered in a state where the inside of the punch guide hole 211 is closed off, air in the closed space in the punch guide hole 211 is compressed. However, since the vent hole 218 is formed in the present embodiment, the air in the punch guide hole 211 can be released to the outside from the vent hole 218. As a result, air is not compressed in the punch guide hole 211, and the punch 220 can be smoothly operated.

Next, as shown in FIG. 4D, the control section 25 further lowers the punch 220 and starts the punch process of punching the medium P. When the tip end section 221 of the punch 220 comes into contact with the medium P, a portion of the medium P contacted by the tip end section 221 of the punch 220 is pressed downward and deformed, and the medium P is pressed radially outward in a direction away from the center, with the portion with which the tip end section 221 contacts as the center.

Next, as shown in FIG. 4E, the control section 25 further lowers the punch 220. Accordingly, the part of the medium P that deformed downward by being pressing by the tip end section 221 of the punch 220 is cut by the die blade 105 under the pressing force from the punch 220. In addition, since the tip end section 221 of the punch 220 that contacts the medium P has a conical shape, the cross sectional area of the tip end section 221 gradually increases, and thus a portion of the medium P is further pressed radially in a direction away from the center, with the portion with which the tip end section 221 is contact as the center. Since the medium P is pressed by the pressing section 215 and the movement of the medium P is regulated, the radially pressed portion of the medium P is compressed in the plane direction of the medium P. That is, part of the medium P that is punch processed by the punch 220 in the punch process section 46 is cut, but the other portion is compressed in the medium P.

In addition, since the medium P is pressed at the portion pressed by the pressing section 215 of the medium P, the portion other than the portion subjected to the punch process is less likely to be torn.

In the drawing, a part of the medium P compressed by the punch 220 is schematically indicated by hatching.

Next, as shown in FIGS. 4F and 4G of the drawing, the control section 25 further lowers the punch 220. Accordingly, the cut portion (cutting waste W) of the medium P moves downward together with the tip end section 221 of the punch 220. On the other hand, the compressed portion of the medium P is further pressed radially by the outer peripheral surface of the main body section (cylindrical section) of the punch 220 and further compressed.

Next, as shown in FIG. 4H, the control section 25 further lowers the punch 220. As a result, the tip end section 221 of the punch 220 presses the brush 110, and the tip end section 221 moves below the brush 110. In addition, the cutting waste W adhering to the tip end section 221 of the punch 220 moves to between the lower end section of the die 100 and the brush 110.

Next, as shown in FIG. 4J, the control section 25 further lowers the punch 220. As a result, the tip end section 221 of the punch 220 and the cutting waste W adhering to the tip end section 221 move to a position below the brush 110. When the punch 220 reaches a predetermined position, the control section 25 stops lowering the punch 220.

In the punch process, the punch 220 is lowered at a predetermined constant speed.

Next, as shown in FIG. 4K, the control section 25 raises the punch 220. As a result, the punch 220 moves upward. On the other hand, the cutting waste W adhered to the tip end section 221 of the punch 220 is repelled by the brush 110 and separated from the punch 220. The cutting waste W can be easily removed from the punch 220 by the brush 110.

Next, as shown in FIG. 4L, the control section 25 further raises the punch 220. When the punch 220 reaches a predetermined position, the raising of the punch 220 is stopped. On the other hand, the cutting waste W separated from the punch 220 falls and collects on the bottom surface 300a of the receiving section 300. As a result, diffusion of the cutting waste W in the first unit 5 can be prevented.

In the punch process, the punch 220 is lifted at a predetermined constant speed.

Next, as shown in FIG. 4M, the control section 25 raises the punch guide 210. When the punch guide 210 reaches a predetermined position, the raising of the punch guide 210 is stopped. Accordingly, the medium P is released.

As described above, the punch process in the punch process section 46 is completed. Two punched holes Pa are formed in the medium P by the punch process.

Thereafter, the control section 25 drives the transport section 90 to export the medium P on which the punch process has been completed from the support surface 100a of the die 100 to the downstream side. Thereafter, the same punch process as described above is repeated.

As described above, according to the present embodiment, since the tip end section 221 of the punch 220 has the conical shape, the punch process is performed in a state in which a portion of the medium P is cut and the other portion is compressed in the medium P. Accordingly, since the compressed portion of the medium P is not cut, it is possible to reduce the amount of the cutting waste W generated in the punch process.

### 2. Second Embodiment

Next, a second embodiment will be described. Note that the same configuration as in the first embodiment is denoted by the same reference numerals, and redundant description will be omitted.

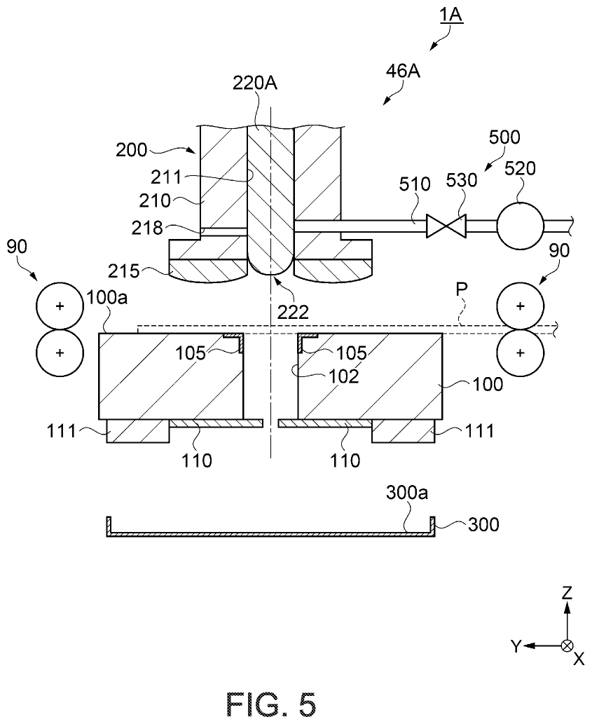

As shown in FIG. 5, a punch process section 46A of a recording system 1A of the present embodiment includes the die 100 that can support the medium P, and the punch unit 200 that performs the punch process to punch the hole in the supported medium P.

The punch unit 200 includes the pressing section 215 that presses the medium P in cooperation with the die 100, a punch 220A that can move up and down, the punch guide 210 that accommodates the punch 220A and has the punch guide hole 211 that guides the punch 220A during the up and down movement, and a liquid supplying mechanism 500 that supplies liquid (for example, water) that can permeate the medium P to the punch guide hole 211.

The punch 220A has a cylindrical rod shape. A tip end section 222 of the punch 220A has a spherical shape. The punch 220A is disposed along the Z-axis so that the tip end section 222 is oriented in the −Z direction.

The liquid supply mechanism 500 includes a bendable tube 510 and a pump 520 for supplying liquid to the punch guide hole 211 through the tube 510. The pump 520 is connected to a supply of liquid.

The tube 510 is formed of an elastic member. As a result, the tube 510 becomes displaceable, and the liquid can be easily supplied in response to the up and down movement of the punch guide 210.

One end of the tube 510 is connected to the pump 520, and the other end is connected to a side portion of the punch guide 210. More specifically, the punch guide 210 is formed with a through hole penetrating laterally from the punch guide hole 211, and the other end of the tube 510 is inserted into the through hole.

The liquid supply mechanism 500 is capable of adjusting a supply amount of liquid. Specifically, a valve 530 is connected to an intermediate section of the tube 510. The valve 530 includes an electromagnetic valve. The amount of liquid supplied can be adjusted by controlling the electromagnetic valve. The supply amount of the liquid can be adjusted according to the thickness, the material, and the like of the medium P, and the punch process can be easily performed.

Note that configuration of the punch guide 210, the pressing section 215, the vent hole 218, the die 100, the brush 110, the receiving section 300, and the transport section 90 are the same as those in the first embodiment, and thus description thereof will be omitted.

Next, a control configuration of the punch process section 46A of the recording system 1A will be described.

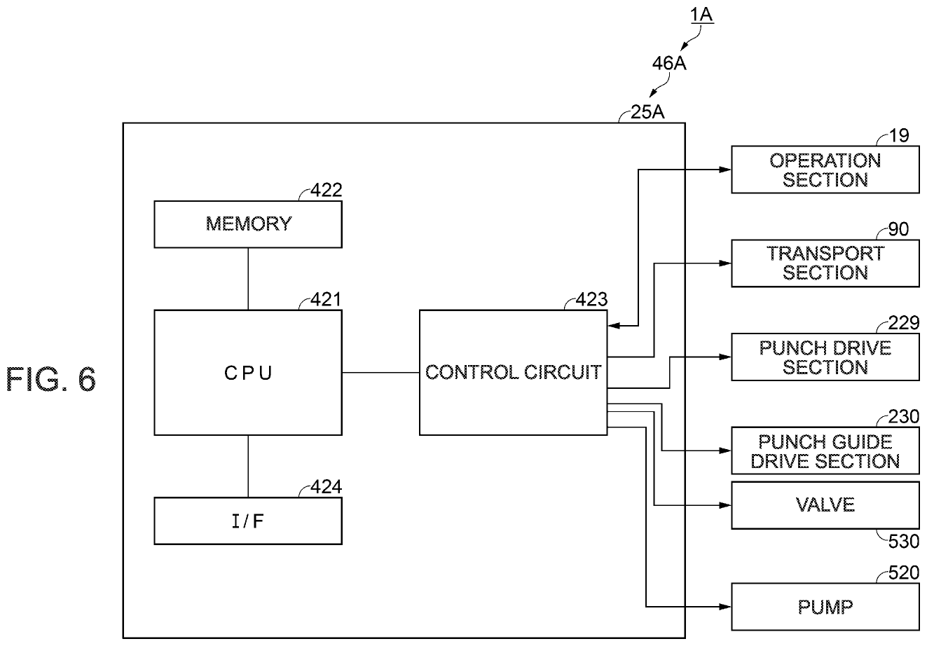

As shown in FIG. 6, the recording system 1A includes a control section 25A that controls various operations performed in the recording system LA. The control section 25A includes the CPU 421, the memory 422, the control circuit 423, and the interface (I/F) 424. In the punch process section 46A, the control circuit 423 is connected to the operation section 19, the transport section 90, the punch drive section 229, the punch guide drive section 230, the pump 520, and the valve 530. When the control section 25A obtains, for example, an execution command from the operation section 19 or record data or the like from an external information processing terminal or the like via the I/F 424, the CPU 421 executes arithmetic processes in accordance with various programs, and controls each drive unit or the like via the control circuit 423.

Next, a control method of the punch process section 46A will be described.

In the punch process section 46A of the present embodiment, after the medium P is pressed by the die 100 and the pressing section 215, the liquid is supplied to the punch guide hole 211, and then the punch 220A is lowered to perform the punch process.

A specific description will be given below.

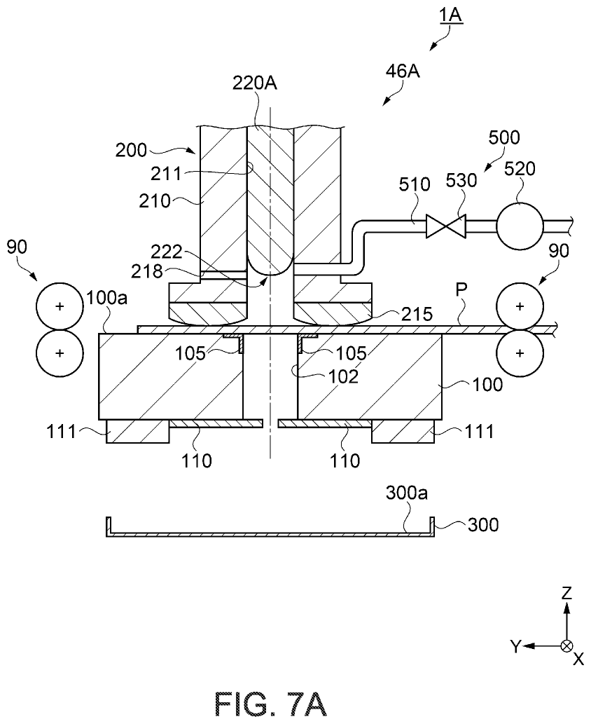

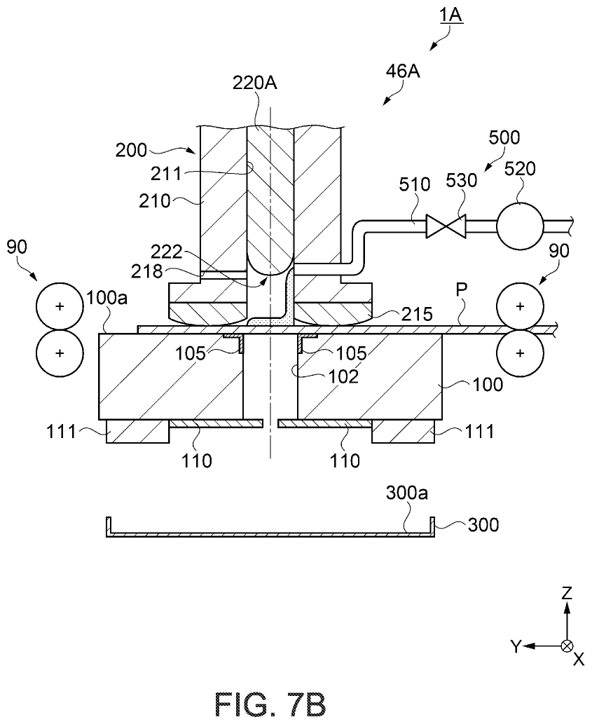

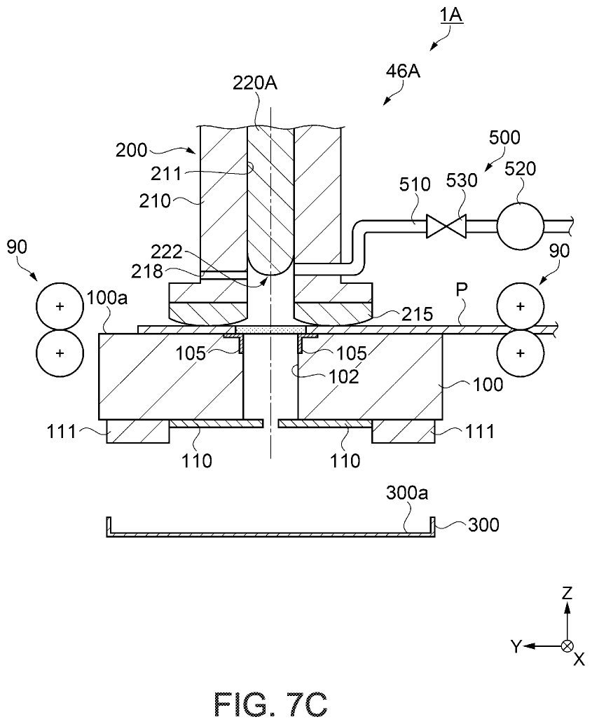

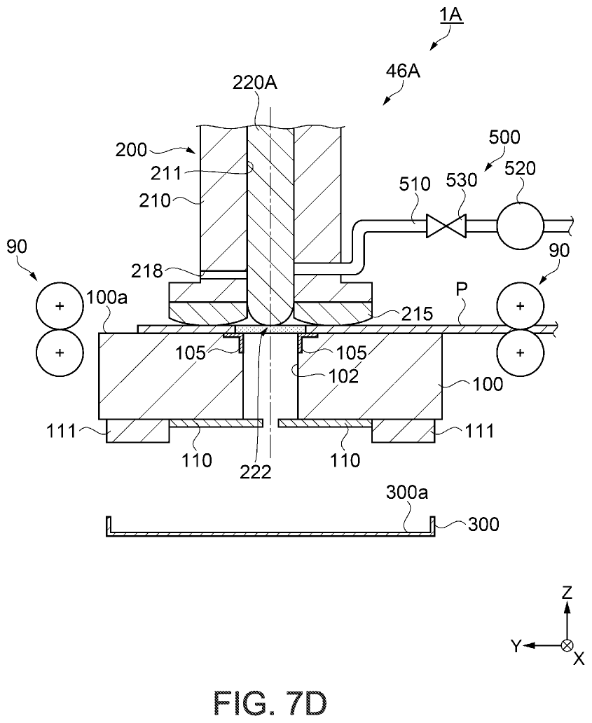

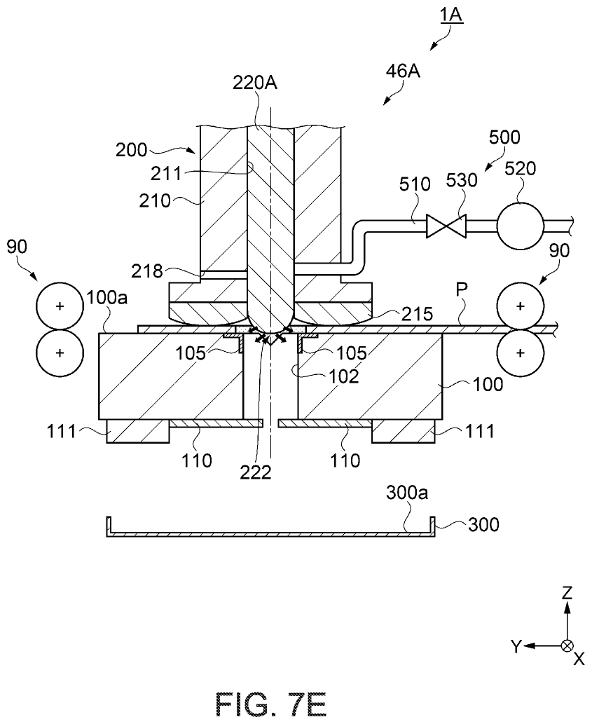

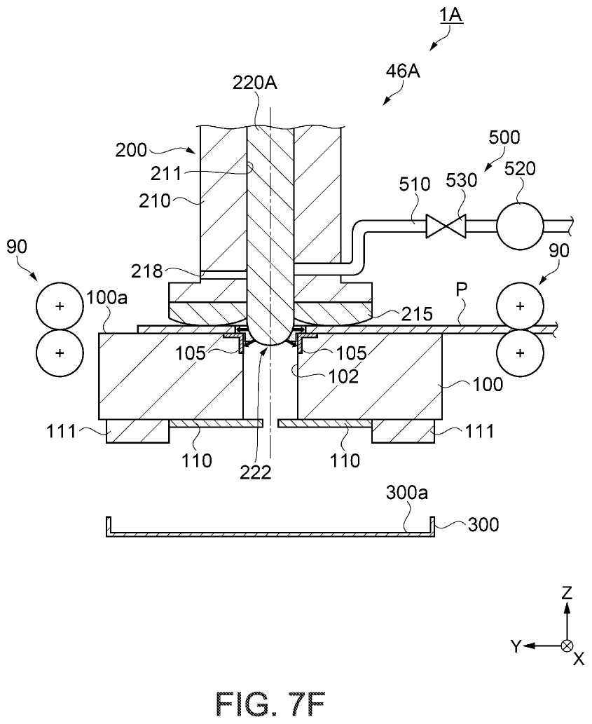

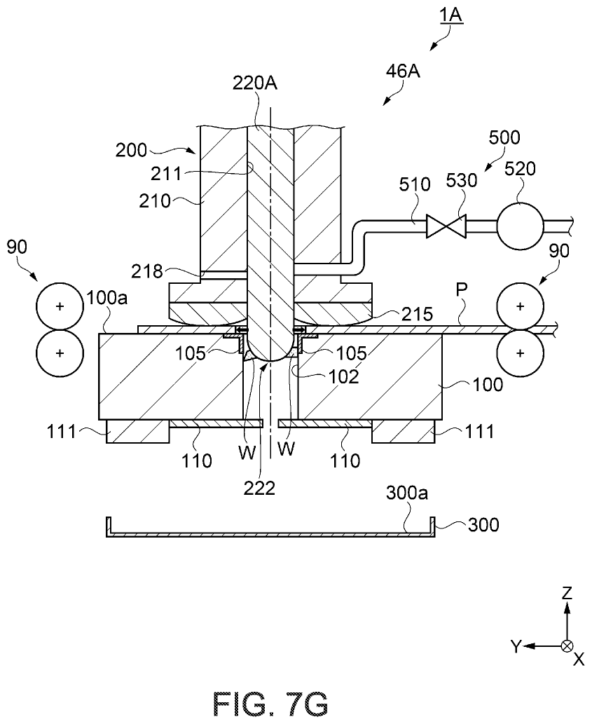

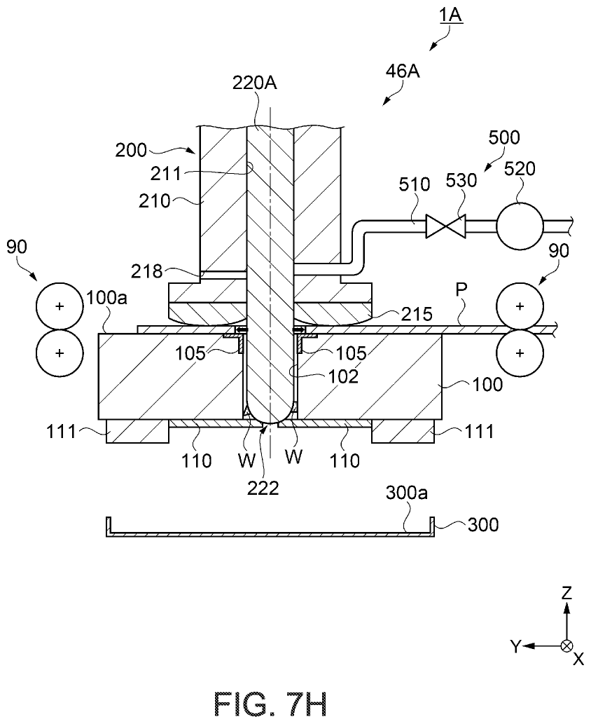

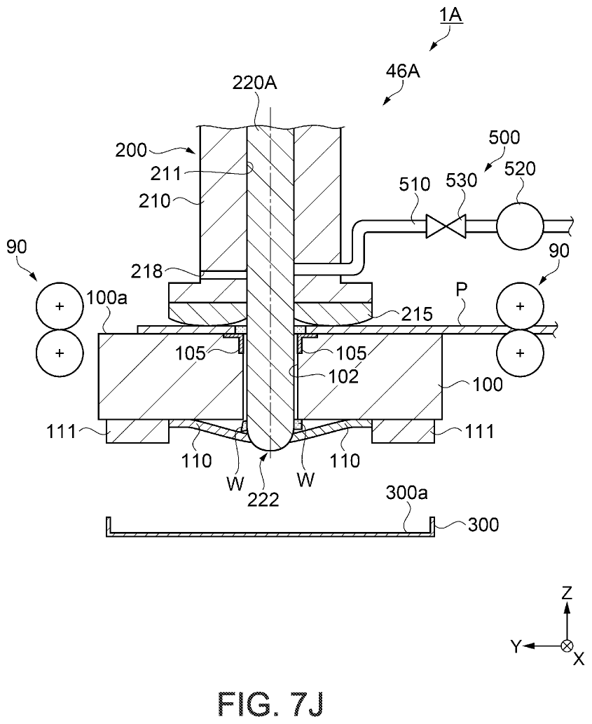

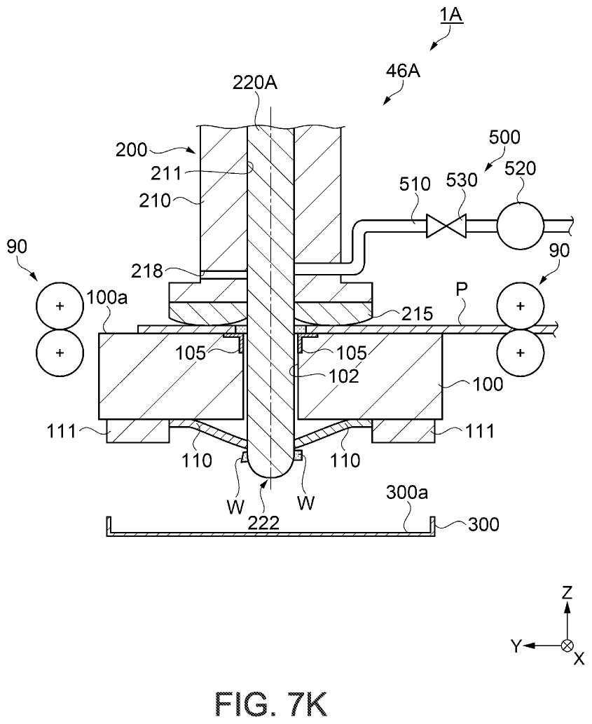

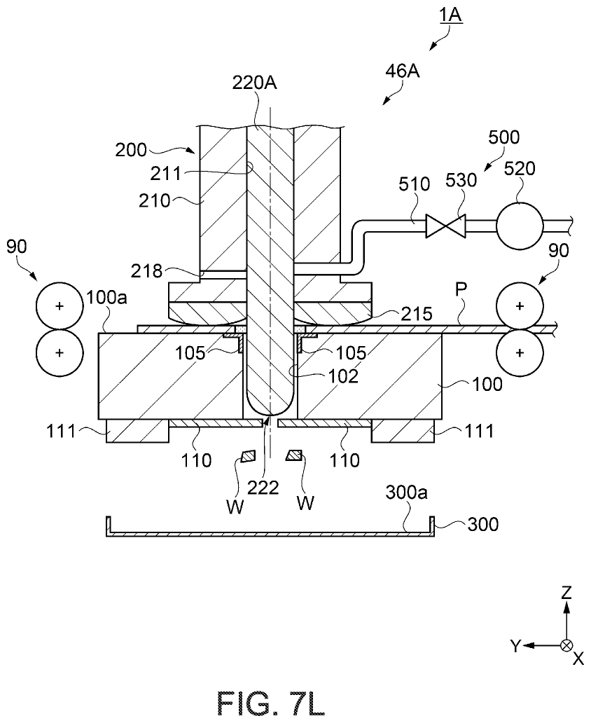

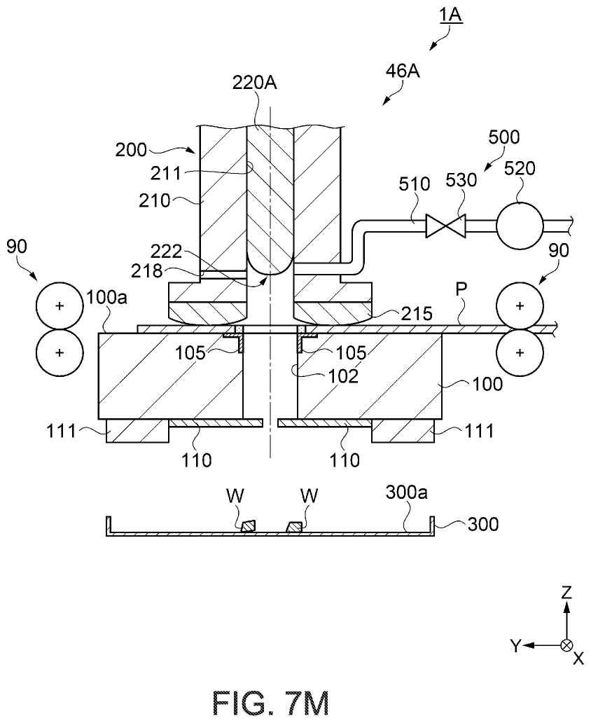

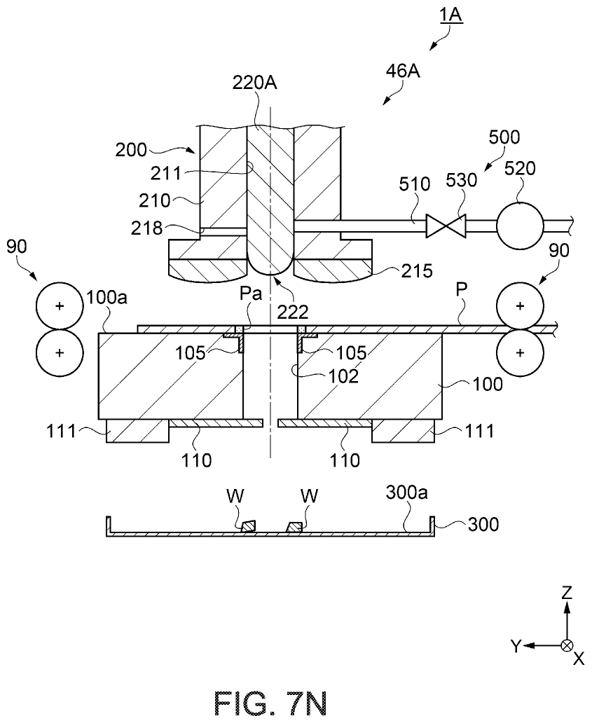

First, as shown in FIG. 7A, the control section 25A drives the transport section 90 to transport the medium P. As a result, the medium P is supported by the support surface 100a of the die 100. When the medium P is supported at a predetermined position, the drive of the transport section 90 is stopped.

Then, the control section 25A causes the punch guide 210 lower and causes the pressing section 215 to press the medium P downward. Accordingly, the medium P is pressed by the die 100 and the pressing section 215.

At this time, the punch 220A is held above the die 100.

As the punch guide 210 is lowered, a part of the tube 510 of the liquid supply mechanism 500 is held in a bent state.

Next, as shown in FIG. 7B, the control section 25A causes the liquid to be supplied to the punch guide hole 211 in a state in which the punch guide 210, the pressing section 215, the punch 220A, and the medium P are closed off. By this, the valve 530 is opened, and the liquid flows into the punch guide hole 211 by drive of the pump 520. The liquid flowing in the punch guide hole 211 stays at the portion of the medium P surrounded by the pressing section 215. When a predetermined amount of the liquid is supplied, the control section 25A closes the valve 530 to stop the supply of the liquid.

Then, as shown in FIG. 7C, the liquid flowing into the punch guide hole 211 permeates into the medium P.

Next, as shown in FIG. 7D, the control section 25A lowers the punch 220A. When the punch 220A lowered, air in the punch guide hole 211 is released out from the vent hole 218, so that the punch 220A can be smoothly operated.

Next, as shown in FIG. 7E, the control section 25A further lowers the punch 220A and starts the punch process of punching the medium P. When the tip end section 222 of the punch 220A comes into contact with the medium P, a portion of the medium P contacted by the tip end section 222 of the punch 220A is pressed downward and deformed, and the medium P is radially pressed in a direction away from a center, with the portion contacted by tip end section 222 as the center. Since the portion of the medium P into which the liquid has permeated becomes softer than other portions, the portion of the medium P against which the tip end section 222 of the punch 220A contacts is pressed downward to be easily deformed, and the medium P is easily pressed radially in a direction away from the center, with the portion contacted by the tip end section 222 as the center. In addition, since the punch process can be performed with a relatively weak force, wear of the tip end section 222 of the punch 220A can be suppressed.

Next, as shown in FIG. 7F, the control section 25A further lowers the punch 220A. Accordingly, a part of the medium P deformed downward by the pressing of the tip end section 222 of the punch 220A is cut by the die blade 105 by the pressing of the punch 220A. In addition, since the tip end section 222 of the punch 220A with which the medium P is contacted has a spherical shape, the cross sectional area of the tip end section 222 gradually increases, and thus a portion of the medium P is further pressed radially in a direction away from the center, with the portion that the tip end section 222 contacts as the center. Since the medium P is pressed by the pressing section 215 and the movement of the medium P is regulated, the radially pressed portion of the medium P is compressed in the plane direction of the medium P. That is, the part of the medium P undergoing the punch process by the punch 220A in the punch process section 46A is cut, but the other portions are compressed in the medium P.

Further, since the portion of the medium P to be subjected to the punch process is softer than other portions, the portions other than the portion to be punch processed are less likely to be torn.

In the drawing, the part of the medium P compressed by the punch 220A is indicated by hatching.

Next, as shown in FIG. 7G and FIG. 7H, the control section 25A further lowers the punch 220A. Accordingly, the cutting waste W which is the cut portion of the medium P moves downward together with the tip end section 222 of the punch 220A. On the other hand, the compressed portion of the medium P is further pressed radially by the outer peripheral surface of the main body section (cylindrical section) of the punch 220A and further compressed.

Next, as shown in FIG. 7J, the control section 25A further lowers the punch 220A. As a result, the tip end section 222 of the punch 220A presses the brush 110, and moves below the brush 110. In addition, the cutting waste W adhering to the tip end section 222 of the punch 220A moves to between the lower end section of the die 100 and the brush 110.

Next, as shown in FIG. 7K, the control section 25A further lowers the punch 220A. As a result, the tip end section 222 of the punch 220A and the cutting waste W adhering to the tip end section 222 move to a position below the brush 110. When the punch 220A reaches a predetermined position, the control section 25A stops lowering the punch 220A.

Next, as shown in FIG. 7L, the control section 25A raises the punch 220A. As a result, the punch 220A moves upward. On the other hand, the cutting waste W adhered to the tip end section 222 of the punch 220A is repelled by the brush 110 and the cutting waste W is separated from the punch 220A.

Next, as shown in FIG. 7M, the control section 25A further raises the punch 220A. When the punch 220A reaches a predetermined position, the raising of the punch 220A is stopped. On the other hand, the cutting waste W that separated from the punch 220A falls and collects on the bottom surface 300a of the receiving section 300. As a result, diffusion of the cutting waste W in the first unit 5 can be prevented.

Next, as shown in FIG. 7N, the control section 25A raises the punch guide 210. When the punch guide 210 reaches a predetermined position, the raising of the punch guide 210 is stopped. Accordingly, the medium P is released.

As described above, the punch process in the punch process section 46A is completed. Two punched holes Pa are formed in the medium P by the punch process.

Thereafter, the control section 25A drives the transport section 90 to transport the medium P on which the punch process has been completed downstream from the support surface 100a of the die 100. Thereafter, the same punch process as described above is repeated.

As described above, according to the present embodiment, the liquid permeates into the medium P by the supply of the liquid to the punch guide hole 211. Since the portion of the medium P where the liquid has permeated becomes softer than other portions, the portion where the punch 220A contacts on the medium P is easily compressed. Since the compressed portion of the medium P is not cut, it is possible to reduce the amount of the cutting waste W generated in the punch process.

### 3. Third Embodiment

Next, a third embodiment will be described. Note that the same configuration as in the first and second embodiments are denoted by the same reference numerals, and redundant description will be omitted.

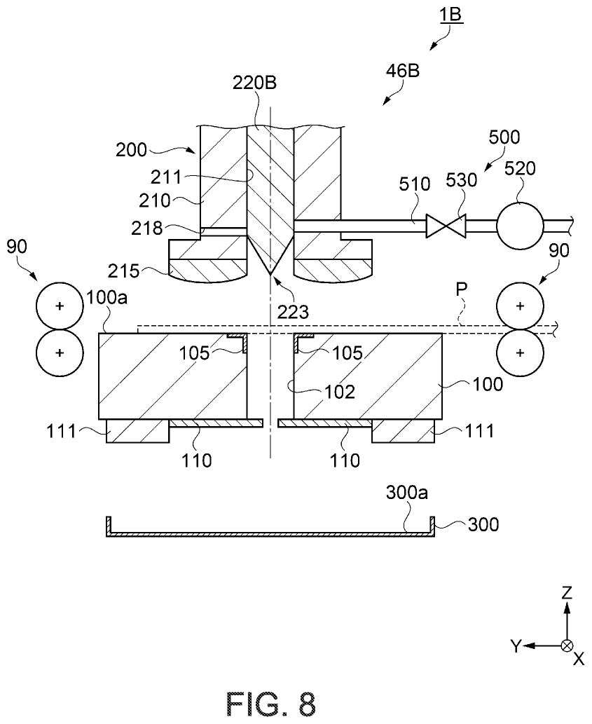

As shown in FIG. 8, a punch process section 46B of a recording system 1B of the present embodiment includes the die 100 that can support the medium P, and the punch unit 200 that performs punch process on the supported medium P.

The punch unit 200 includes the pressing section 215 that presses the medium P in cooperation with the die 100, a punch 220B that can move up and down, the punch guide 210 that accommodates the punch 220B and has the punch guide hole 211 that guides the punch 220B during the up and down movement, and the liquid supplying mechanism 500 that supplies liquid (for example, water) that can permeate the medium P to the punch guide hole 211.

The punch 220B has a cylindrical rod shape. The punch 220B has a conical shaped tip end section 223. The punch 220B is disposed along the Z-axis so that the tip end section 223 is oriented in the −Z direction.

The liquid supply mechanism 500 includes the bendable tube 510 and the pump 520 for supplying liquid to the punch guide hole 211 through the tube 510.

Since the structure of the liquid supply mechanism 500 is the same as that of the second embodiment, a description thereof is omitted. Further, the configurations of the punch guide 210, the pressing section 215, the vent hole 218, the die 100, the brush 110, the receiving section 300, and the transport section 90 are the same as those in the first embodiment, and thus description thereof will be omitted.

Next, a control configuration of the punch process section 46B of the recording system 1B will be described.

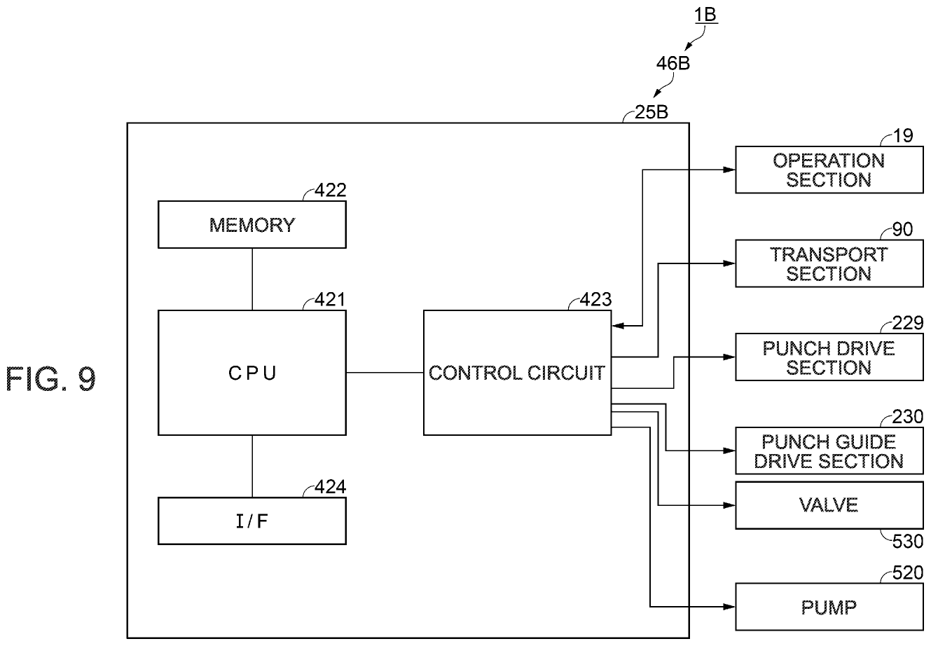

As shown in FIG. 9, the recording system 1B includes a control section 25B for controlling various operations executed by the recording system 1B. The control section 25B includes the CPU 421, the memory 422, the control circuit 423, and the interface (I/F) 424. In the punch process section 46B, the control circuit 423 is connected to the operation section 19, the transport section 90, the punch drive section 229, the punch guide drive section 230, the pump 520, and the valve 530. When the control section 25B obtains, for example, an execution command from the operation section 19 or record data or the like from an external information processing terminal or the like via the I/F 424, the CPU 421 executes arithmetic process in accordance with each program, and controls each drive unit or the like via the control circuit 423.

Next, a control method of the punch process section 46B will be described.

In the punch process section 46B of the present embodiment, after the medium P is pressed by the die 100 and the pressing section 215, the liquid is supplied to the punch guide hole 211, and then the punch 220B is lowered to perform the punch process.

A specific description will be given below.

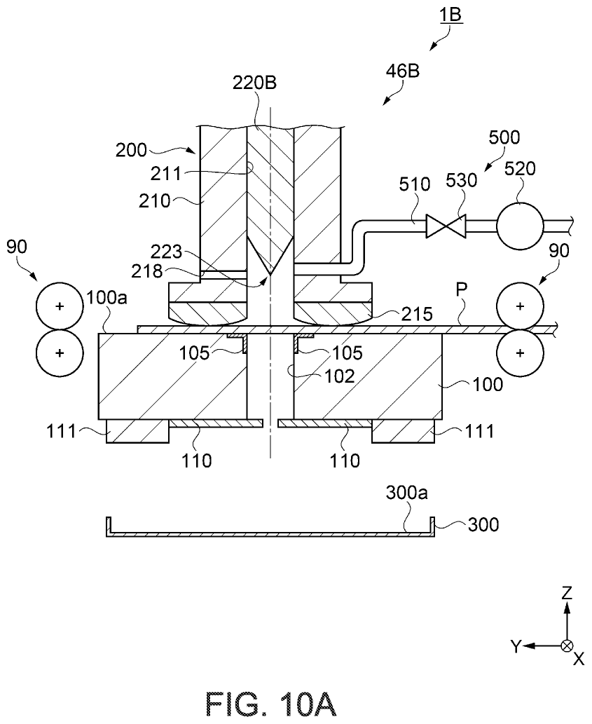

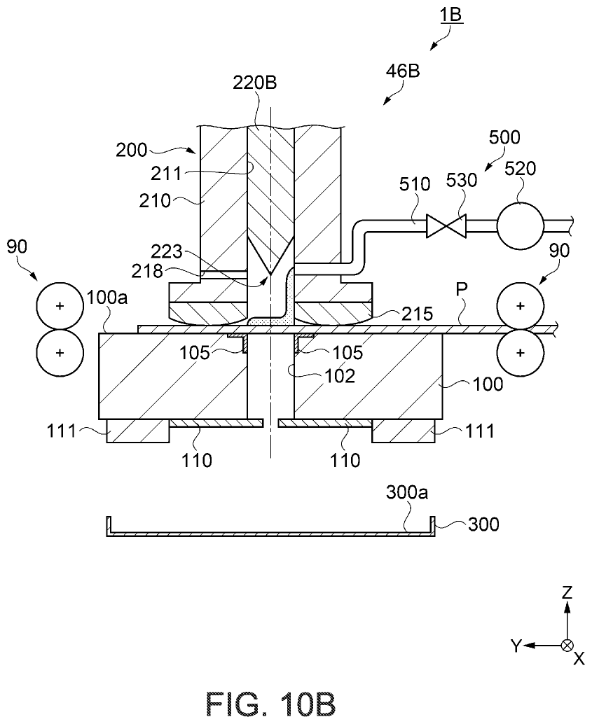

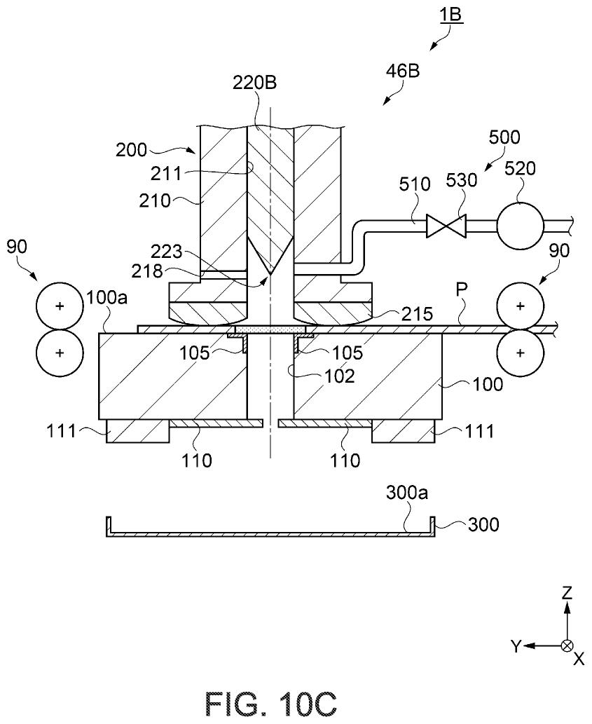

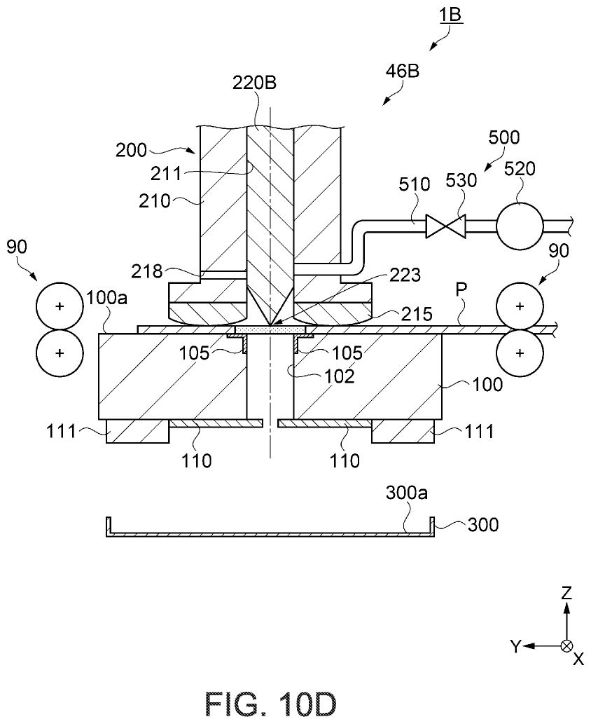

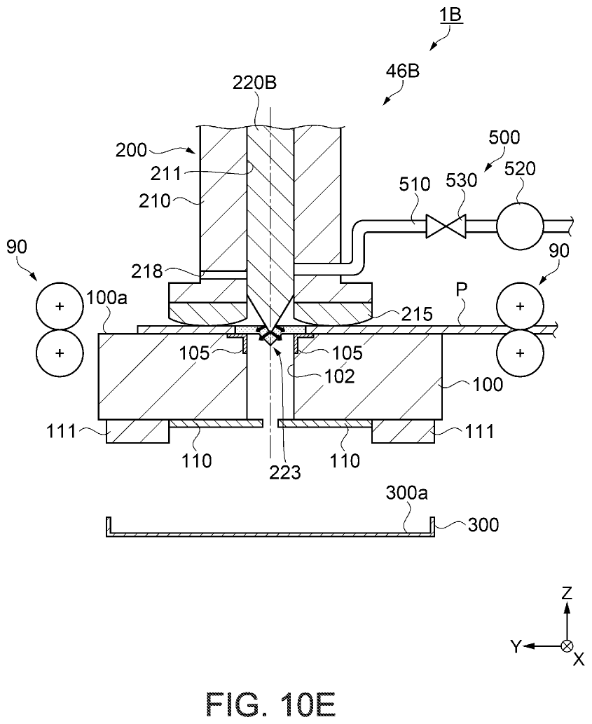

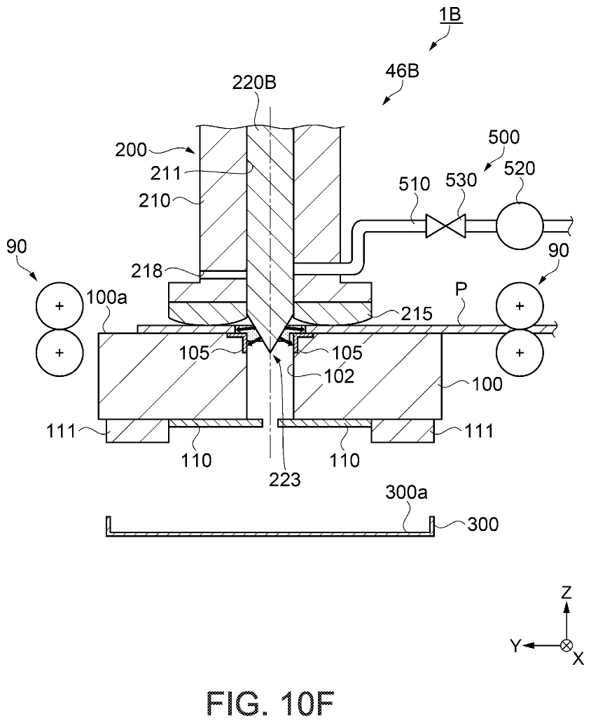

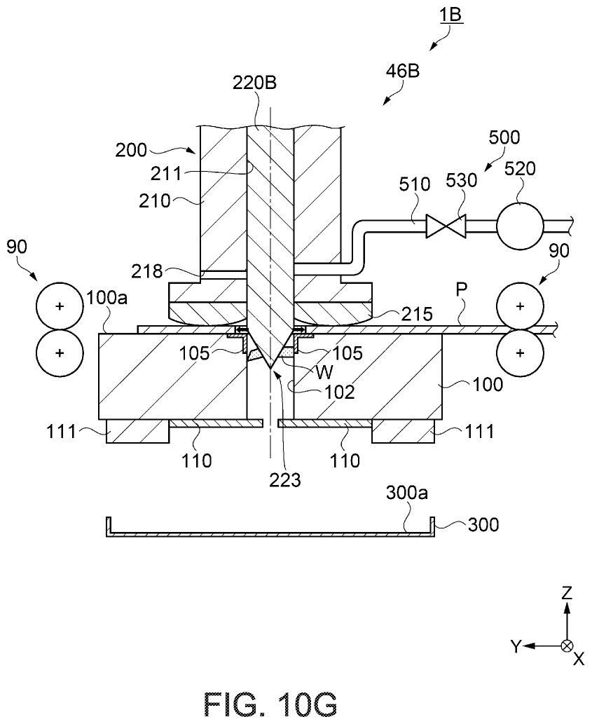

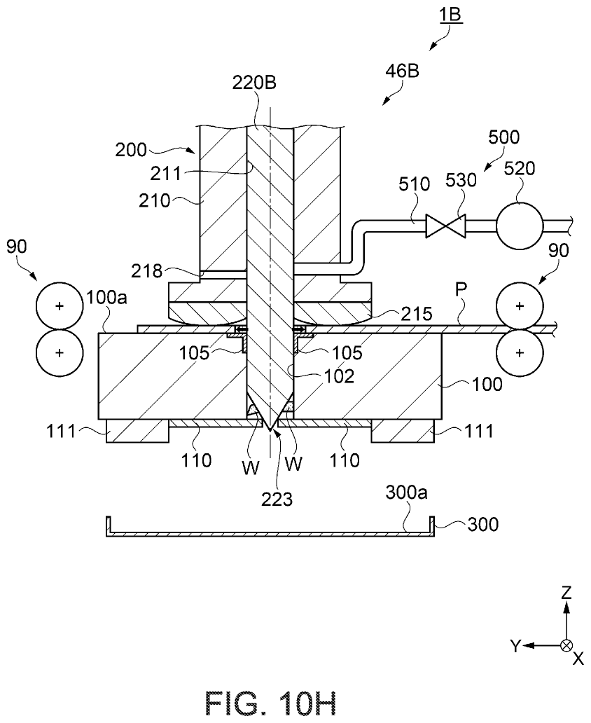

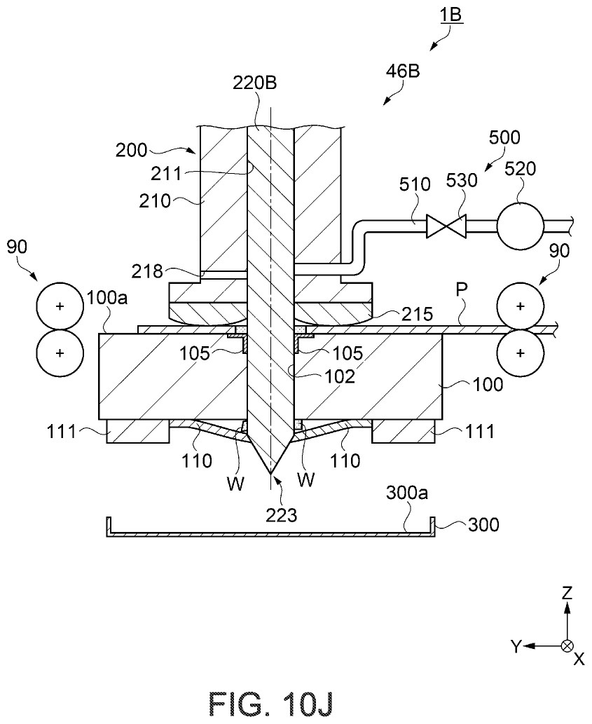

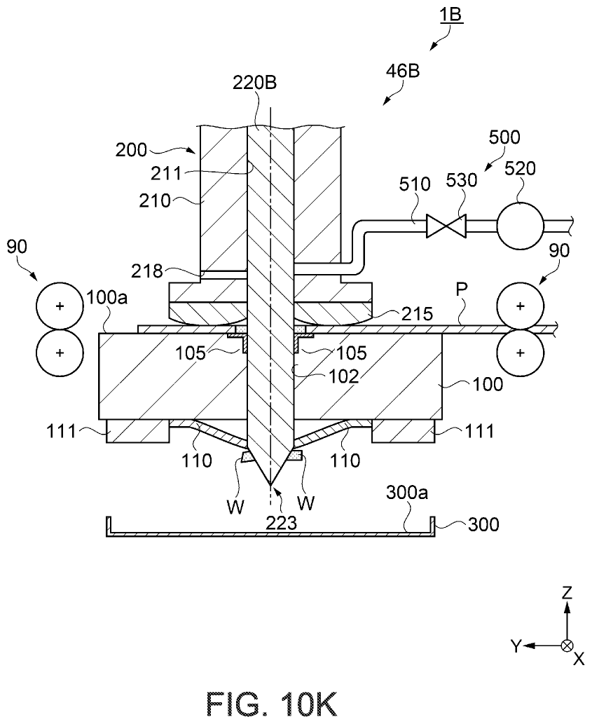

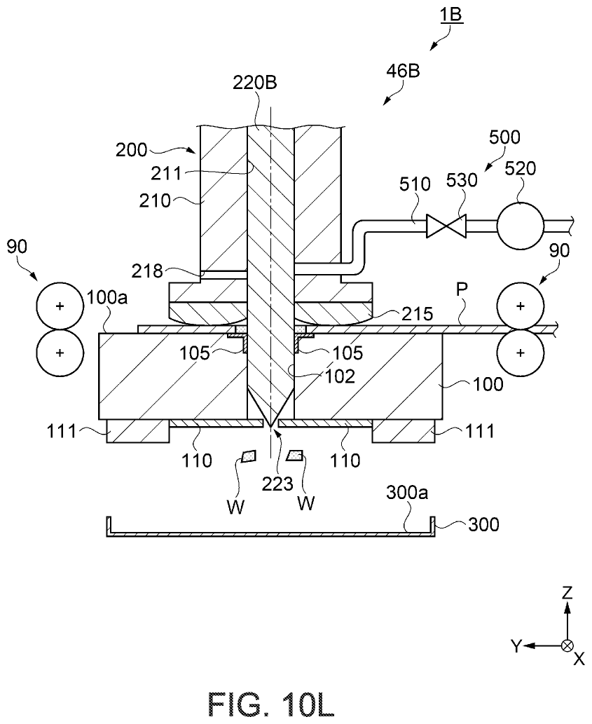

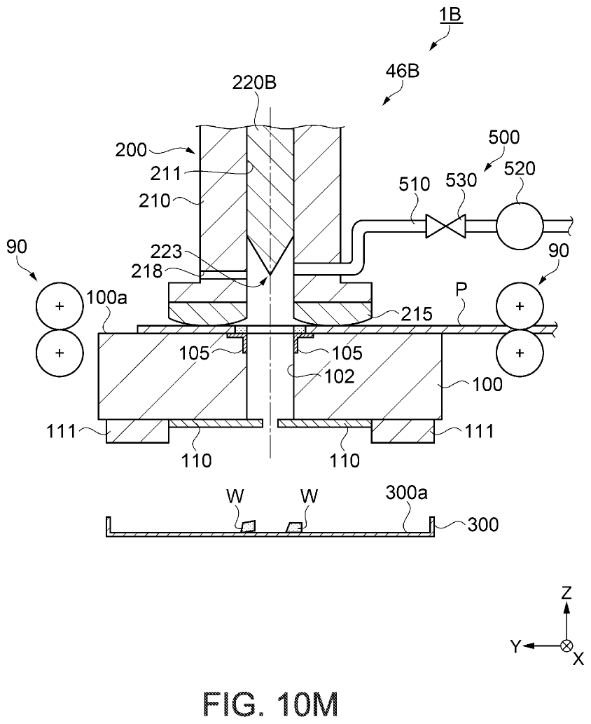

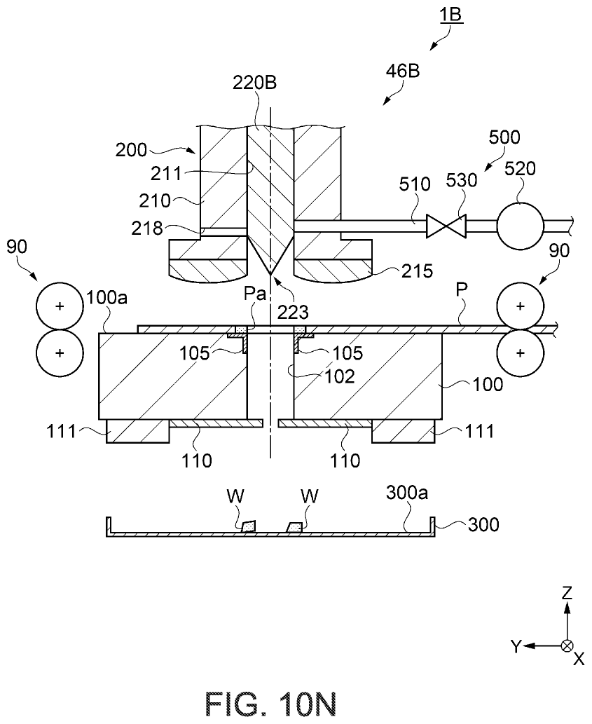

First, as shown in FIG. 10A, the control section 25B drives the transport section 90 to transport the medium P. As a result, the medium P is supported by the support surface 100a of the die 100. When the medium P is supported at a predetermined position, the drive of the transport section 90 is stopped.

Then, the control section 25B causes the punch guide 210 to lower and causes the pressing section 215 to press the medium P downward. Accordingly, the medium P is pressed by the die 100 and the pressing section 215.

At this time, the punch 220B is held above the die 100.

As the punch guide 210 is lowered, a part of the tube 510 of the liquid supply mechanism 500 is held in a bent state.

Next, as shown in FIG. 10B, the control section 25B causes the liquid to be supplied to the punch guide hole 211 in a state in which the punch guide 210, the pressing section 215, the punch 220B, and the medium P are closed off. By this, the valve 530 is opened, and the liquid flows into the punch guide hole 211 by drive of the pump 520. The liquid flowing in the punch guide hole 211 stays at the portion of the medium P surrounded by the pressing section 215. When a predetermined amount of the liquid is supplied, the control section 25B closes the valve 530 to stop the supply of liquid.

Then, as shown in FIG. 10C, the liquid flowing into the punch guide hole 211 permeates inside the medium P.

Next, as shown in FIG. 10D, the control section 25B lowers the punch 220B. When the punch 220B lowered, air in the punch guide hole 211 is released out from the vent hole 218, so that the punch 220B can be smoothly operated.

Next, as shown in FIG. 10E, the control section 25B further lowers the punch 220B and starts the punch process of punching the medium P. When the tip end section 223 of the punch 220B comes into contact with the medium P, a portion of the medium P contacted by the tip end section 223 of the punch 220B is pressed downward and deformed, and the medium P is radially pressed in a direction away from a center, with the portion contacted by the tip end section 223 as the center. Since the portion of the medium P into which the liquid has permeated becomes softer than other portions, the portion of the medium P contacted by the tip end section 223 of the punch 220B is pressed downward and easily deformed, and the medium P is easily pressed radially in a direction away from the center with the portion contacted by the tip end section 223 as the center. In addition, since the punch process can be performed with a relatively weak force, wear of the tip end section 223 of the punch 220B can be suppressed.

Next, as shown in FIG. 10F, the control section 25B further lowers the punch 220B. Accordingly, the part of the medium P deformed downward by the pressing of the tip end section 223 of the punch 220B is cut by the die blade 105 by the pressing of the punch 220B. In addition, since the tip end section 223 of the punch 220B that contacts the medium P has a conical shape, the cross sectional area of the tip end section 223 gradually increases, and thus a portion of the medium P is further pressed radially in a direction away from the center, with the portion contacted by the tip end section 223 as the center. Since the medium P is pressed by the pressing section 215 and the movement of the medium P is regulated, the radially pressed portion of the medium P is compressed in the plane direction of the medium P. That is, part of the medium P punch processed by the punch 220B in the punch process section 46B is cut, but another portion is compressed in the medium P.

Further, since a portion of the medium P to be punch processed is softer than other portions due to penetration of the liquid, the portion other than the punch processed portion is less likely to be torn.

In the drawing, the part of the medium P compressed by the punch 220B is indicated by hatching.

Next, as shown in FIG. 10G and FIG. 10H, the control section 25B further lowers the punch 220B. Accordingly, the cutting waste W, which is the cut portion of the medium P, moves downward together with the tip end section 223 of the punch 220B. On the other hand, the portion of the medium P to be compressed is further pressed radially by the outer peripheral surface of the main body section (cylindrical section) of the punch 220B and further compressed.

Next, as shown in FIG. 10J, the control section 25B further lowers the punch 220B. As a result, the tip end section 223 of the punch 220B presses the brush 110, and moves below the brush 110. In addition, the cutting waste W adhering to the tip end section 223 of the punch 220B moves to between the lower end section of the die 100 and the brush 110.

Next, as shown in FIG. 10K, the control section 25B further lowers the punch 220B. As a result, the tip end section 223 of the punch 220B and the cutting waste W adhering to the tip end section 223 move to a position below the brush 110. When the punch 220B reaches a predetermined position, the control section 25B stops lowering the punch 220B.

Next, as shown in FIG. 10L, the control section 25B raises the punch 220B. As a result, the punch 220B moves upward. On the other hand, the cutting waste W adhered to the tip end section 223 of the punch 220B is repelled by the brush 110 and the cutting waste W is separated from the punch 220B.

Next, as shown in FIG. 10M, the control section 25B further raises the punch 220B. When the punch 220B reaches a predetermined position, raising of the punch 220B is stopped. On the other hand, the cutting waste W separated from the punch 220B falls and collects at the bottom surface 300a of the receiving section 300. As a result, diffusion of the cutting waste W in the first unit 5 can be prevented.

Next, as shown in FIG. 10N, the control section 25B raises the punch guide 210. When the punch guide 210 reaches a predetermined position, raising of the punch guide 210 is stopped. Accordingly, the medium P is released.

By this, the punch process in the punch process section 46B is completed. Two punched holes Pa are formed in the medium P by the punch process.

Thereafter, the control section 25B drives the transport section 90 to export the medium P on which the punch process has been completed from the support surface 100a of the die 100 to the downstream side. Thereafter, the same punch process as described above is repeated.

As described above, according to the present embodiment, the liquid permeates into the medium P by the supply of the liquid to the punch guide hole 211. Since the portion of the medium P where the liquid has permeated becomes softer than other portions, the portion where the punch 220B contacts the medium P is easily compressed. Further, according to the present embodiment, since the tip end section 223 of the punch 220B has a conical shape, the punch process is performed in a state in which a portion of the medium P is cut and the other portion is compressed in the medium P. Since the compressed portion of the medium P is not cut, it is possible to reduce the amount of the cutting waste W generated in the punch process.

What is claimed is:

1. A punching device, comprising:
a die configured to support a paper sheet and a punch unit configured to perform a punch process on the supported sheet, wherein
the punch unit includes
a pressing section configured to press the sheet in cooperation with the die,
a punch that has a conical shaped tip end section and that is configured to move up and down, and
a punch guide hole configured to accommodate the punch and to guide the punch in up and down movement and
the die includes
a hole section provided in a portion facing the punch and through which the punch is passable,
a die blade provided at an upper end periphery of the hole section and configured to cut the sheet in cooperation with the punch, and
after the sheet is pressed by the die and the pressing section, the punch that has a conical shaped tip end section process is performed by lowering the punch and bringing the tip end section into contact with the paper.

2. The punching device according to claim 1, further comprising:
a liquid supply mechanism configured to supply a liquid capable of permeating the sheet to the punch guide hole.

3. The punching device according to claim 2, wherein
the liquid supply mechanism includes a tube configured to bend and a pump configured to supply the liquid to the punch guide hole via the tube.

4. The punching device according to claim 2, wherein
the liquid supply mechanism is configured to adjust a supply amount of the liquid.

5. The punching device according to claim 1, further comprising:
a brush provided at a lower portion of the hole section and configured to contact with the tip end section of the lowered punch.

6. The punching device according to claim 1, further comprising:
a receiving section provided below the hole section of the die and configured to receive waste generated when the punch process is performed.

7. The punching device according to claim 1, further comprising:
a transport section configured to transport the sheet onto a support surface of the die and to transport the sheet out after the punch process.

8. A punching device, comprising:
a die configured to support a paper sheet and a punch unit configured to perform a punch process on the supported sheet, wherein
the punch unit includes
a pressing section configured to press the sheet in cooperation with the die,
a punch configured to move up and down,
a punch guide hole configured to accommodate the punch and to guide the punch in up and down movement, and
a liquid supply mechanism configured to supply a liquid capable of permeating the sheet to the punch guide hole and
the die includes
a hole section provided in a portion facing the punch and through which the punch is passable,
a die blade provided at an upper end periphery of the hole section and configured to cut the sheet in cooperation with the punch, and
after the sheet is pressed by the die and the pressing section, the liquid is supplied to the punch guide hole and then the punch is lowered to perform the punch process.

9. A control method for a punching device, the punching device including:
a die configured to support a paper sheet and a punch unit configured to perform a punch process on the supported sheet, wherein
the punch unit includes
a pressing section configured to press the sheet in cooperation with the die,
a punch that has a conical shaped tip end section and that is configured to move up and down, and
a punch guide hole configured to accommodate the punch and to guide the punch in up and down movement and
the die includes
a hole section provided in a portion facing the punch and through which the punch is passable and
a die blade provided at an upper end periphery of the hole section and configured to cut the sheet in cooperation with the punch,
the control method comprising:
performing the punch process by, after pressing the sheet by the die and the pressing section, lowering the punch and bringing the tip end section into contact with the paper.

10. A control method for a punching device, the punching device including:
a die configured to support a paper sheet and a punch unit configured to perform a punch process on the supported sheet, wherein
the punch unit includes
a pressing section configured to press the sheet in cooperation with the die,
a punch configured to move up and down,
a punch guide hole configured to accommodate the punch and to guide the punch in up and down movement, and
a liquid supply mechanism configured to supply a liquid capable of permeating the sheet to the punch guide hole and
the die includes
a hole section provided in a portion facing the punch and through which the punch is passable and
a die blade provided at an upper end periphery of the hole section and configured to cut the sheet in cooperation with the punch,
the control method comprising:
performing the punch process by, after pressing the sheet by the die and the pressing section, supplying the liquid to the punch guide hole, and then lowering the punch.
